(19) United States
(12) Patent Application Publication
(10) Pub. No.: US 2025/0016830 A1
(43) Pub. Date: Jan. 9, 2025

(54) Coordination of Service Periods

(71) Applicant: Apple Inc., Cupertino, CA (US)

(72) Inventors: Ahmad Reza Hedayat, Carlsbad, CA (US); Jarkko L. Kneckt, Los Gatos, CA (US); Jinjing Jiang, San Jose, CA (US); Su Khiong Yong, Palo Alto, CA (US); Qi Wang, Sunnyvale, CA (US); Sidharth R. Thakur, San Jose, CA (US); Lochan Verma, Danville, CA (US); Yong Liu, Campbell, CA (US)

(21) Appl. No.: 18/760,875

(22) Filed: Jul. 1, 2024

Related U.S. Application Data
(60) Provisional application No. 63/512,438, filed on Jul. 7, 2023.

(51) Int. Cl. H04W 74/0816; H04L 5/00; H04W 84/12

(52) U.S. Cl. CPC H04W 74/0816; H04L 5/0053; H04W 84/12

(57) ABSTRACT

Methods, systems and apparatuses for coordinating service periods by an access point (AP) and a wireless device are described. Information related to coexistence or other reduced availability can be determined and exchanged. A schedule of service periods can be created and can be adjusted as needed.

### PRIORITY INFORMATION

This application claims priority to U.S. Provisional Patent Application No. 63/512,438, entitled “Coordination of Service Periods,” filed Jul. 7, 2023, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, including techniques for wireless communication and coordination of service periods in wireless local area networks.

### DESCRIPTION OF THE RELATED ART

Wireless communication systems are rapidly growing in usage. Further, wireless communication technology has evolved from voice-only communications to also include the transmission of data, such as Internet and multimedia content. A popular short/intermediate range wireless communication standard is wireless local area network (WLAN). Most modern WLANs are based on the IEEE 802.11 standard (and/or 802.11, for short) and are marketed under the Wi-Fi brand name. WLAN networks can link one or more devices to a wireless access point, which in turn provides connectivity to the wider area Internet.

In 802.11 systems, devices that wirelessly connect to each other are referred to as “stations”, “mobile stations”, “user devices”, “user equipment”, or STA or UE for short. Wireless stations can be either wireless access points or wireless clients (and/or mobile stations). Access points (APs), which are also referred to as wireless routers, act as base stations for the wireless network. APs transmit and receive radio frequency signals for communication with wireless client devices. APs can also couple to the Internet in a wired and/or wireless fashion. Wireless clients operating on an 802.11 network can be any of various devices such as laptops, tablet devices, smart phones, smart watches, or fixed devices such as desktop computers. Wireless client devices are referred to herein as user equipment (and/or UE for short). Some wireless client devices are also collectively referred to herein as mobile devices or mobile stations (although, as noted above, wireless client devices overall can be stationary devices as well).

Mobile electronic devices can take the form of smart phones or tablets that a user typically carries. Wearable devices (also referred to as accessory devices) are a newer form of mobile electronic device, one example being smart watches. Additionally, low-cost low-complexity wireless devices intended for stationary or nomadic deployment are also proliferating as part of the developing “Internet of Things”. In other words, there is an increasingly wide range of desired device complexities, capabilities, traffic patterns, and other characteristics.

Some 802.11 devices can communicate with peer devices and/or otherwise experience periods of reduced availability for 802.11 communications. Improvements in the field are desired.

### SUMMARY

Embodiments described herein relate to systems, methods, apparatuses, and mechanisms for coordination of service periods.

In one set of embodiments, a method can comprise: establishing first wireless local area network (WLAN) communication with an access point (AP) and determining a channel usage preference for the WLAN communication based at least in part on second communication, wherein the second communication is not with the AP. The method can comprise transmitting, to the AP, a channel usage request, the channel usage request indicating the channel usage preference and receiving, from the AP, a channel usage response, the channel usage response indicating at least one target wake time (TWT) element. The method can comprise determining, based on the at least one TWT element, a schedule for reduced availability for communication with the AP, the schedule for the reduced availability for communication with the AP comprising a plurality of service periods of reduced availability. The method can comprise determining a modification to the schedule for the reduced availability for communication with the AP and transmitting, to the AP, an indication of the modification of the schedule for the reduced availability for communication with the AP. The method can comprise performing at least one of the first communication with the AP or the second communication according to the modification of the schedule for the reduced availability for communication with the AP.

In one set of embodiments, a method can comprise: providing a basic service set (BSS) and transmitting a broadcast (BC) target-wake-time (TWT) parameter set for the BSS, wherein the BC TWT indicates an service period (SP) during which the BSS will be unavailable via at least one link.

In one set of embodiments, a method can comprise: establishing wireless local area network (WLAN) communication with an access point (AP). The method can comprise determining coexistence information related to the WLAN communication, the coexistence information comprising at least one of: information related to clock drift; information related to an interference level of a co-located radio; detailed timing information of one or more coexistence event; or channel mapping information. The method can comprise transmitting, to the AP, an indication of the coexistence information and communicating, with the AP, according to the coexistence information.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system, according to some embodiments.

FIG. 2 illustrates an example simplified block diagram of a wireless device, according to some embodiments.

FIG. 3 illustrates an example WLAN communication system, according to some embodiments.

FIG. 4 illustrates an example simplified block diagram of a WLAN Access Point (AP), according to some embodiments.

FIG. 5 illustrates an example simplified block diagram of a wireless station (STA), according to some embodiments.

FIG. 6 illustrates an example simplified block diagram of a wireless node, according to some embodiments.

FIG. 7 illustrates an example method of communication, according to some embodiments.

FIGS. 8-27 illustrate example aspects of the method of FIG. 7, according to some embodiments.

FIG. 28 illustrates an example method of communication, according to some embodiments.

FIGS. 29-32 illustrate example aspects of the method of FIG. 28, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present application. Definitions of some acronyms that can appear throughout the present application are provided below:
UE: User Equipment
AP: Access Point
STA: Wireless Station
TX: Transmission/Transmit
RX: Reception/Receive
MLD: Multi-link Device
LAN: Local Area Network
WLAN: Wireless LAN
RAT: Radio Access Technology
QoS: Quality of Service
UL: Uplink
DL: Downlink
P2P: peer-to-peer

### Terminology

The following is a glossary of terms used in this disclosure:

Memory Medium-Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium can include other types of non-transitory memory as well or combinations thereof. In addition, the memory medium can be located in a first computer system in which the programs are executed, or can be located in a second different computer system which connects to the first computer system over a network, such as the Internet. In the latter instance, the second computer system can provide program instructions to the first computer for execution. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (and/or combination of devices) having at least one processor that executes instructions from a memory medium.

Mobile Device (and/or Mobile Station)—any of various types of computer systems devices which are mobile or portable and which performs wireless communications using WLAN communication. Examples of mobile devices include mobile telephones or smart phones (e.g., iPhone™, Android™-based phones), and tablet computers such as iPad™, Samsung Galaxy™, etc. Various other types of devices would fall into this category if they include Wi-Fi or both cellular and Wi-Fi communication capabilities, such as laptop computers (e.g., MacBook™), portable gaming devices (e.g., Nintendo DS™, PlayStation Portable™, Gameboy Advance™, iPhone™), portable Internet devices, and other handheld devices, as well as wearable devices such as smart watches, smart glasses, headphones, pendants, earpieces, etc. In general, the term “mobile device” can be broadly defined to encompass any electronic, computing, and/or telecommunications device (and/or combination of devices) which is easily transported by a user and capable of wireless communication using WLAN or Wi-Fi.

Wireless Device (and/or Wireless Station)—any of various types of computer systems devices which performs wireless communications using WLAN communications. As used herein, the term “wireless device” can refer to a mobile device, as defined above, or to a stationary device, such as a stationary wireless client or a wireless base station. For example, a wireless device can be any type of wireless station of an 802.11 system, such as an access point (AP) or a client station (STA or UE). Further examples include televisions, media players (e.g., AppleTV™, Roku™, Amazon FireTV™, Google Chromecast™, etc.), refrigerators, laundry machines, thermostats, and so forth.

WLAN—The term “WLAN” has the full breadth of its ordinary meaning, and at least includes a wireless communication network or RAT that is serviced by WLAN access points and which provides connectivity through these access points to the Internet. Most modern WLANs are based on IEEE 802.11 standards and are marketed under the name “Wi-Fi”. A WLAN network is different from a cellular network.

Processing Element—refers to various implementations of digital circuitry that perform a function in a computer system. Additionally, processing element can refer to various implementations of analog or mixed-signal (combination of analog and digital) circuitry that perform a function (and/or functions) in a computer or computer system. Processing elements include, for example, circuits such as an integrated circuit (IC), ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure can be initiated by input provided by the user, but the subsequent actions that are performed “automatically” are not specified by the user, e.g., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form can be automatically filled out by the computer system where the computer system (e.g., software executing on the computer system) analyzes the fields of the form and fills in the form without any user input specifying the answers to the fields. As indicated above, the user can invoke the automatic filling of the form, but is not involved in the actual filling of the form (e.g., the user is not manually specifying answers to fields but rather they are being automatically completed). The present specification provides various examples of operations being automatically performed in response to actions the user has taken.

Concurrent—refers to parallel execution or performance, where tasks, processes, signaling, messaging, or programs are performed in an at least partially overlapping manner. For example, concurrency can be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

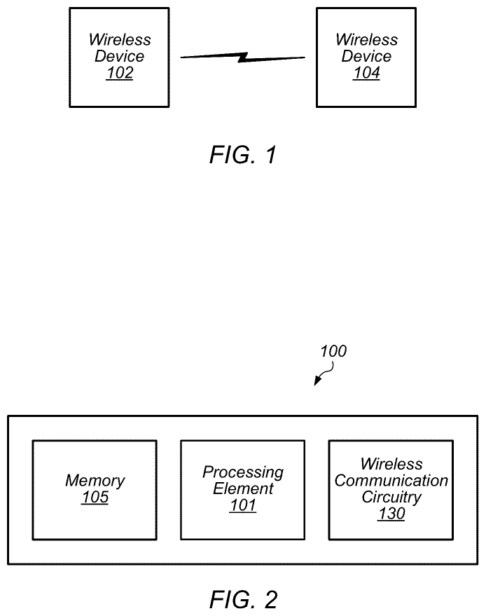

### FIGS. 1-2—Wireless Communication System

FIG. 1 illustrates an exemplary (and simplified) wireless communication system in which aspects of this disclosure can be implemented. It is noted that the system of FIG. 1 is merely one example of a possible system, and embodiments of this disclosure can be implemented in any of various systems, as desired.

As shown, the exemplary wireless communication system includes a (“first”) wireless device 102 in communication with another (“second”) wireless device. The first wireless device 102 and the second wireless device 104 can communicate wirelessly using any of a variety of wireless communication techniques.

As one possibility, the first wireless device 102 and the second wireless device 104 can perform communication using wireless local area networking (WLAN) communication technology (e.g., IEEE 802.11/Wi-Fi based communication) and/or techniques based on WLAN wireless communication. One or both of the wireless device 102 and the wireless device 104 can also be capable of communicating via one or more additional wireless communication protocols, such as any of Bluetooth (BT), Bluetooth Low Energy (BLE), near field communication (NFC), GSM, UMTS (WCDMA, TDSCDMA), LTE, LTE-Advanced (LTE-A), NR, 3GPP2 CDMA2000 (e.g., 1×RTT, 1×EV-DO, HRPD, cHRPD), etc. Further, one or both of the wireless device 102 and the wireless device 104 can also be capable of GPS, etc.

The wireless devices 102 and 104 can be any of a variety of types of wireless device. As one possibility, one or more of the wireless devices 102 and/or 104 can be a substantially portable wireless user equipment (UE) device, such as a smart phone, hand-held device, a wearable device such as a smart watch, a tablet, a motor vehicle, or virtually any type of wireless device. As another possibility, one or more of the wireless devices 102 and/or 104 can be a substantially stationary device, such as a set top box, media player (e.g., an audio or audiovisual device), gaming console, desktop computer, appliance, door, access point, base station, or any of a variety of other types of device.

Each of the wireless devices 102 and 104 can include wireless communication circuitry configured to facilitate the performance of wireless communication, which can include various digital and/or analog radio frequency (RF) components, a processor that is configured to execute program instructions stored in memory, a programmable hardware element such as a field-programmable gate array (FPGA), and/or any of various other components. The wireless device 102 and/or the wireless device 104 can perform any of the method embodiments described herein, or any portion of any of the method embodiments described herein, using any or all of such components.

Each of the wireless devices 102 and 104 can include one or more antennas for communicating using one or more wireless communication protocols. In some cases, one or more parts of a receive and/or transmit chain can be shared between multiple wireless communication standards; for example, a device can be configured to communicate using either of Bluetooth or Wi-Fi using partially or entirely shared wireless communication circuitry (e.g., using a shared radio or at least shared radio components). The shared communication circuitry can include a single antenna, or can include multiple antennas (e.g., for MIMO) for performing wireless communications. Alternatively, a device can include separate transmit and/or receive chains (e.g., including separate antennas and other radio components) for each wireless communication protocol with which it is configured to communicate. As a further possibility, a device can include one or more radios or radio components which are shared between multiple wireless communication protocols, and one or more radios or radio components which are used exclusively by a single wireless communication protocol. For example, a device can include a shared radio for communicating using one or more of LTE, CDMA2000 1×RTT, GSM, and/or 5G NR, and separate radios for communicating using each of Wi-Fi and Bluetooth. Other configurations are also possible and contemplated.

As previously noted, aspects of this disclosure can be implemented in conjunction with the wireless communication system of FIG. 1. For example, a wireless device (e.g., either of wireless devices 102 or 104) can be configured to perform methods for coordination of service periods, as variously described herein. For example, the wireless device can communicate with an AP and determining a channel usage preference based at least in part on second communication that is not with the AP. The device can transmit to the AP, a channel usage request indicating the channel usage preference and can receive from the AP, a channel usage response indicating at least one target wake time (TWT) element. The device can determine based on the at least one TWT element, a schedule for reduced availability for communication with the AP, the schedule comprising a plurality of service periods of reduced availability. The device can determine a modification to the schedule for the reduced availability for communication with the AP and transmit, to the AP, an indication of the modification The device can perform at least one of the first communication with the AP or the second communication according to the modification.

FIG. 2 illustrates an exemplary wireless device 100 (e.g., corresponding to wireless devices 102 and/or 104) that can be configured for use in conjunction with various aspects of the present disclosure. The device 100 can be any of a variety of types of device and can be configured to perform any of a variety of types of functionality. The device 100 can be a substantially portable device or can be a substantially stationary device, potentially including any of a variety of types of device. The device 100 can be configured to perform one or more wireless communication techniques or features, such as any of the techniques or features illustrated and/or described subsequently herein with respect to any or all of the Figures.

As shown, the device 100 can include a processing element 101. The processing element can include or be coupled to one or more memory elements. For example, the device 100 can include one or more memory media (e.g., memory 105), which can include any of a variety of types of memory and can serve any of a variety of functions. For example, memory 105 could be RAM serving as a system memory for processing element 101. Other types and functions are also possible.

Additionally, the device 100 can include wireless communication circuitry 130. The wireless communication circuitry can include any of a variety of communication elements (e.g., antenna(s) for wireless communication, analog and/or digital communication circuitry/controllers, etc.) and can enable the device to wirelessly communicate using one or more wireless communication protocols.

Note that in some cases, the wireless communication circuitry 130 can include its own processing element (e.g., a baseband processor), e.g., in addition to the processing element 101. For example, the processing element 101 can be an ‘application processor’ whose primary function can be to support application layer operations in the device 100, while the wireless communication circuitry 130 can be a ‘baseband processor’ whose primary function can be to support baseband layer operations (e.g., to facilitate wireless communication between the device 100 and other devices) in the device 100. In other words, in some cases the device 100 can include multiple processing elements (e.g., can be a multi-processor device). Other configurations (e.g., instead of or in addition to an application processor/baseband processor configuration) utilizing a multi-processor architecture are also possible.

The device 100 can additionally include any of a variety of other components (not shown) for implementing device functionality, depending on the intended functionality of the device 100, which can include further processing and/or memory elements (e.g., audio processing circuitry), one or more power supply elements (which can rely on battery power and/or an external power source) user interface elements (e.g., display, speaker, microphone, camera, keyboard, mouse, touchscreen, etc.), and/or any of various other components.

The components of the device 100, such as processing element 101, memory 105, and wireless communication circuitry 130, can be operatively coupled via one or more interconnection interfaces, which can include any of a variety of types of interface, possibly including a combination of multiple types of interface. As one example, a USB high-speed inter-chip (HSIC) interface can be provided for inter-chip communications between processing elements. Alternatively (and/or in addition), a universal asynchronous receiver transmitter (UART) interface, a serial peripheral interface (SPI), inter-integrated circuit (I2C), system management bus (SMBus), and/or any of a variety of other communication interfaces can be used for communications between various device components. Other types of interfaces (e.g., intra-chip interfaces for communication within processing element 101, peripheral interfaces for communication with peripheral components within or external to device 100, etc.) can also be provided as part of device 100.

In some embodiments, the device 100 can be a multi-link device (MLD), e.g., capable of communicating using multiple different links simultaneously.

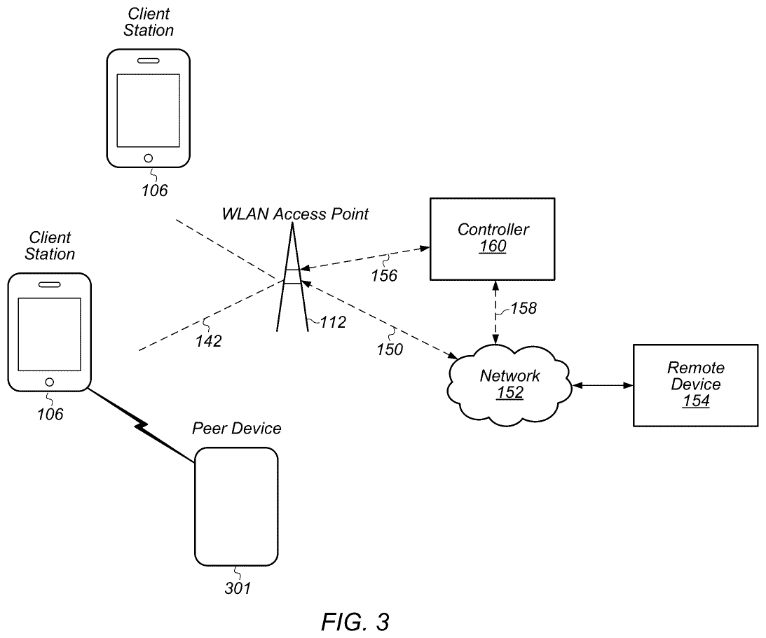

### FIG. 3—WLAN System

FIG. 3 illustrates an example WLAN system according to some embodiments. As shown, the exemplary WLAN system includes a plurality of wireless client stations or devices (e.g., STAs or user equipment (UEs)), 106 that are configured to communicate over a wireless communication channel 142 with an Access Point (AP) 112. The AP 112 can be a Wi-Fi access point. The AP 112 can communicate via a wired and/or a wireless communication channel 150 with one or more other electronic devices (not shown) and/or another network 152, such as the Internet. Additional electronic devices, such as the remote device 154, can communicate with components of the WLAN system via the network 152. For example, the remote device 154 can be another wireless client station, a server associated with an application executing on one of the STAs 106, etc. The WLAN system can be configured to operate according to any of various communications standards, such as the various IEEE 802.11 standards. In some embodiments, at least one wireless device 106 is configured to communicate directly with one or more neighboring mobile devices, without use of the access point 112.

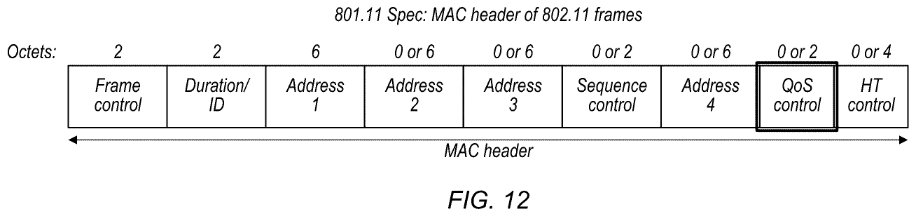

In some embodiments, AP 112 can communicate via a wired and/or a wireless communication channel 156 (and/or a combination of channels 150 and 158) with a controller 160 (see also: FIG. 12). The controller can manage a wireless network (e.g., at an airport, stadium, campus, office, home, or any other facility or location) including one or more APs. The APs can share a common extended service set identifier (ESSID). In some embodiments, the APs can advertise a common service set identifier (SSID) (e.g., “XYZ airport”, etc.). In some embodiments, the controller can be separate from the APs and can communicate with the APs via a direct connection (e.g., 156) and/or via the internet (e.g., via a combination of 150, 152, 158). In some embodiments, the controller can be housed in/with one of the APs and can communicate with the other APs via direct connection (e.g., 156) and/or via the internet (e.g., via a combination of 150, 152, 158).

Further, in some embodiments, a wireless device 106 (which can be an exemplary implementation of device 100) can be configured to communicate with one or more peer device 301 or perform other communication outside of the BSS of the AP 112 (e.g., non-WLAN communication). This communication can be peer-to-peer (P2P) communication and can occur using WLAN and/or any other RAT(s). The wireless device 106, AP 112, and/or peer device 301 can be configured to perform methods for communication in a manner to include periods for communication between the wireless device 106 and AP 112 interspersed with service periods for communication between the wireless device 106 and peer device 301 and/or other communication outside of the BSS of the AP 112.

It will be appreciated that the wireless device 106 and/or AP 112 can be multi-link devices (MLDs). For example, the wireless device 106 and AP 112 can use one or multiple links to communicate. For example, such links can include links on a 2.4 GHz band, 5 GHz band, and/or 6 GHz band, among various possibilities. The wireless device can be a non-AP MLD, e.g., with multiple affiliated STAs. The AP can be an AP MLD, e.g., with multiple affiliated APs.

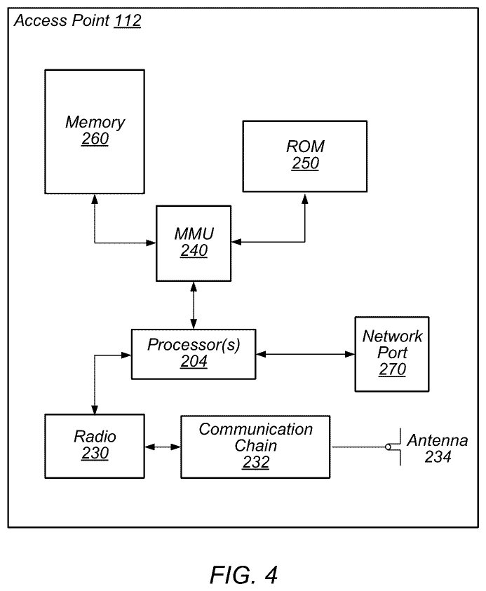

### FIG. 4—Access Point Block Diagram

FIG. 4 illustrates an exemplary block diagram of an access point (AP) 112, which can be one possible exemplary implementation of the device 100 illustrated in FIG. 4. It is noted that the block diagram of the AP of FIG. 4 is only one example of a possible system. As shown, the AP 112 can include processor(s) 204 which can execute program instructions for the AP 112. The processor(s) 204 can also be coupled (directly or indirectly) to memory management unit (MMU) 240, which can be configured to receive addresses from the processor(s) 204 and to translate those addresses to locations in memory (e.g., memory 260 and read only memory (ROM) 250) or to other circuits or devices.

The AP 112 can include at least one network port 270. The network port 270 can be configured to couple to a wired network and provide a plurality of devices, such as mobile devices 106, access to the Internet. For example, the network port 270 (and/or an additional network port) can be configured to couple to a local network, such as a home network or an enterprise network. For example, port 270 can be an Ethernet port. The local network can provide connectivity to additional networks, such as the Internet.

The AP 112 can include at least one antenna 234, which can be configured to operate as a wireless transceiver and can be further configured to communicate with mobile device 106 via wireless communication circuitry 230. The antenna 234 communicates with the wireless communication circuitry 230 via communication chain 232. Communication chain 232 can include one or more receive chains, one or more transmit chains or both. The wireless communication circuitry 230 can be configured to communicate via Wi-Fi or WLAN, e.g., 802.11. The wireless communication circuitry 230 can also, or alternatively, be configured to communicate via various other wireless communication technologies, including, but not limited to, Long-Term Evolution (LTE), LTE Advanced (LTE-A), Global System for Mobile (GSM), Wideband Code Division Multiple Access (WCDMA), CDMA2000, etc., for example when the AP is co-located with a base station in case of a small cell, or in other instances when it can be desirable for the AP 112 to communicate via various different wireless communication technologies.

Further, in some embodiments, as further described below, AP 112 can be configured to perform methods for communication with a wireless device (e.g., 106) in a manner for coordination of service periods, as variously described herein. For example, the AP can communicate with a STA and can receive a channel usage request from the STA related to communication not with the AP (e.g., indicating the channel usage preference). The AP can transmit a channel usage response indicating at least one target wake time (TWT) element useable to determine a schedule for reduced availability for communication with the AP, the schedule comprising a plurality of service periods of reduced availability. The AP can receive an indication of a modification of the schedule and can communicate according to the modification.

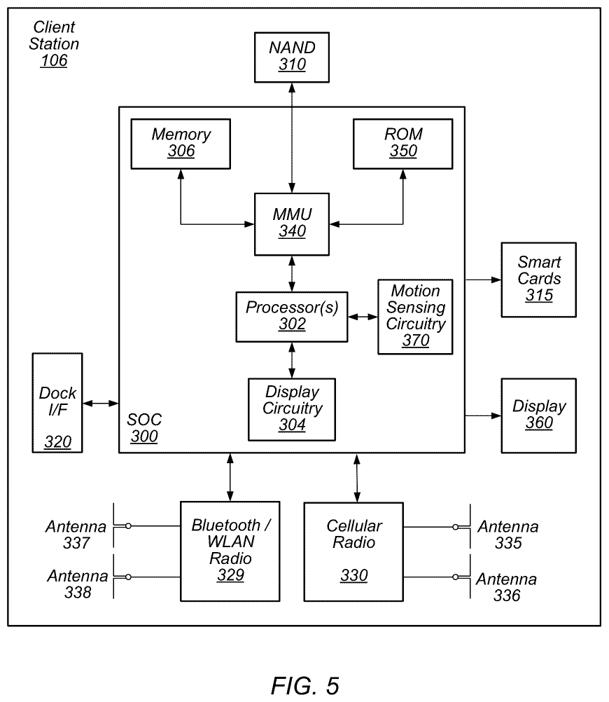

### FIG. 5—Client Station Block Diagram

FIG. 5 illustrates an example simplified block diagram of a client station 106, which can be one possible exemplary implementation of the device 100 illustrated in FIG. 4. According to embodiments, client station 106 can be a user equipment (UE) device, a mobile device or mobile station, and/or a wireless device or wireless station. As shown, the client station 106 can include a system on chip (SOC) 300, which can include portions for various purposes. The SOC 300 can be coupled to various other circuits of the client station 106. For example, the client station 106 can include various types of memory (e.g., including NAND flash 310), a connector interface (I/F) (and/or dock) 320 (e.g., for coupling to a computer system, dock, charging station, etc.), the display 360, cellular communication circuitry (e.g., cellular radio) 330 such as for 5G NR, LTE, GSM, etc., and short to medium range wireless communication circuitry (e.g., Bluetooth™/WLAN radio) 329 (e.g., Bluetooth™ and WLAN circuitry). The client station 106 can further include one or more smart cards 315 that incorporate SIM (Subscriber Identity Module) functionality, such as one or more UICC(s) (Universal Integrated Circuit Card(s)). The cellular communication circuitry 330 can couple to one or more antennas, such as antennas 335 and 336 as shown. The short to medium range wireless communication circuitry 329 can also couple to one or more antennas, such as antennas 337 and 338 as shown. Alternatively, the short to medium range wireless communication circuitry 329 can couple to the antennas 335 and 336 in addition to, or instead of, coupling to the antennas 337 and 338. The short to medium range wireless communication circuitry 329 can include multiple receive chains and/or multiple transmit chains for receiving and/or transmitting multiple spatial streams, such as in a multiple-input multiple output (MIMO) configuration. Some or all components of the short to medium range wireless communication circuitry 329 and/or the cellular communication circuitry 330 can be used for wireless communications, e.g., using WLAN, Bluetooth, and/or cellular communications.

As shown, the SOC 300 can include processor(s) 302, which can execute program instructions for the client station 106 and display circuitry 304, which can perform graphics processing and provide display signals to the display 360. The SOC 300 can also include motion sensing circuitry 370 which can detect motion of the client station 106, for example using a gyroscope, accelerometer, and/or any of various other motion sensing components. The processor(s) 302 can also be coupled to memory management unit (MMU) 340, which can be configured to receive addresses from the processor(s) 302 and translate those addresses to locations in memory (e.g., memory 306, read only memory (ROM) 350, NAND flash memory 310) and/or to other circuits or devices, such as the display circuitry 304, cellular communication circuitry 330, short range wireless communication circuitry 329, connector interface (I/F) 320, and/or display 360. The MMU 340 can be configured to perform memory protection and page table translation or set up. In some embodiments, the MMU 340 can be included as a portion of the processor(s) 302.

As noted above, the client station 106 can be configured to communicate wirelessly directly with one or more neighboring client stations. The client station 106 can be configured to communicate according to a WLAN RAT for communication in a WLAN network, such as that shown in FIG. 3 or in FIG. 1.

As described herein, the client station 106 can include hardware and software components for implementing the features described herein. For example, the processor 302 of the client station 106 can be configured to implement part or all of the features described herein, e.g., by executing program instructions stored on a memory medium (e.g., a non-transitory computer-readable memory medium). Alternatively (and/or in addition), processor 302 can be configured as a programmable hardware element, such as an FPGA (Field Programmable Gate Array), or as an ASIC (Application Specific Integrated Circuit). Alternatively (and/or in addition) the processor 302 of the UE 106, in conjunction with one or more of the other components 300, 304, 306, 310, 315, 320,329, 330, 335, 336, 337, 338, 340, 350, 360, 370 can be configured to implement part or all of the features described herein.

In addition, as described herein, processor 302 can include one or more processing elements. Thus, processor 302 can include one or more integrated circuits (ICs) that are configured to perform the functions of processor 302. In addition, each integrated circuit can include circuitry (e.g., first circuitry, second circuitry, etc.) configured to perform the functions of processor(s) 204.

Further, as described herein, cellular communication circuitry 330 and short-range wireless communication circuitry 329 can each include one or more processing elements. In other words, one or more processing elements can be included in cellular communication circuitry 330 and also in short range wireless communication circuitry 329. Thus, each of cellular communication circuitry 330 and short-range wireless communication circuitry 329 can include one or more integrated circuits (ICs) that are configured to perform the functions of cellular communication circuitry 330 and short-range wireless communication circuitry 329, respectively. In addition, each integrated circuit can include circuitry (e.g., first circuitry, second circuitry, etc.) configured to perform the functions of cellular communication circuitry 330 and short-range wireless communication circuitry 329.

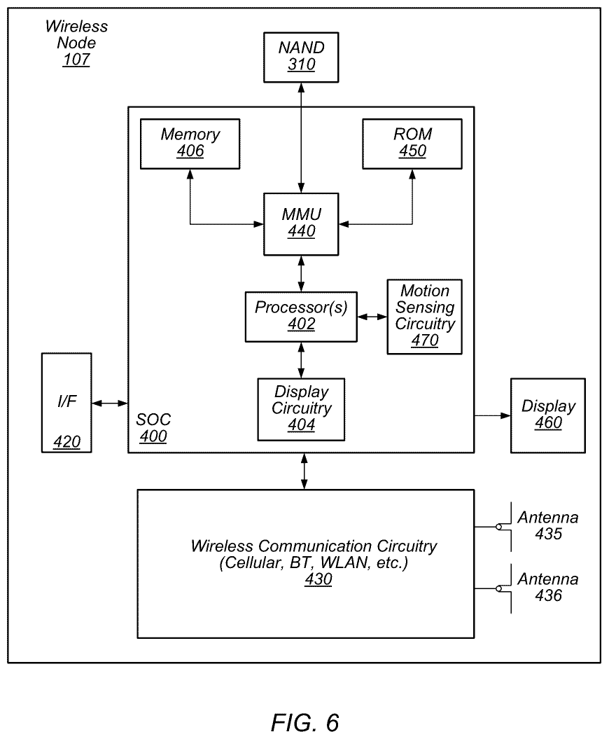

### FIG. 6—Wireless Node Block Diagram

FIG. 6 illustrates an example block diagram of a wireless node 107, which represents an exemplary implementation of the device 106 illustrated in FIG. 5. As shown, the wireless node 107 can include a system on chip (SOC) 400, which can include portions for various purposes. For example, as shown, the SOC 400 can include processor(s) 402 which can execute program instructions for the wireless node 107, and display circuitry 404 which can perform graphics processing and provide display signals to the display 460. The SOC 400 can also include motion sensing circuitry 470 which can detect motion of the wireless node 107, for example using a gyroscope, accelerometer, and/or any of various other motion sensing components. The processor(s) 402 can also be coupled to memory management unit (MMU) 440, which can be configured to receive addresses from the processor(s) 402 and translate those addresses to locations in memory (e.g., memory 406, read only memory (ROM) 450, flash memory 410). The MMU 440 can be configured to perform memory protection and page table translation or set up. In some embodiments, the MMU 440 can be included as a portion of the processor(s) 402.

As shown, the SOC 400 can be coupled to various other circuits of the wireless node 107. For example, the wireless node 107 can include various types of memory (e.g., including NAND flash 410), a connector interface 420 (e.g., for coupling to a computer system, dock, charging station, etc.), the display 460, and wireless communication circuitry 430 (e.g., for 5G NR, LTE, LTE-A, CDMA2000, Bluetooth, Wi-Fi, NFC, GPS, etc.).

The wireless node 107 can include at least one antenna, and in some embodiments, multiple antennas 435 and 436, for performing wireless communication with APs and/or other devices. For example, the wireless node 107 can use antennas 435 and 436 to perform the wireless communication. As noted above, the wireless node 107 can in some embodiments be configured to communicate wirelessly using a plurality of wireless communication standards or radio access technologies (RATs).

The wireless communication circuitry 430 can include one or more logics, SOCs, modules, ICs, and/or processors etc. This circuitry can enable the wireless node 107 to perform Wi-Fi communications, e.g., on an 802.11 network. This circuitry can enable the wireless node 107 to perform Bluetooth communications. This circuitry can enable the wireless node to perform cellular communication according to one or more cellular communication technologies. Some or all components of the wireless communication circuitry 430 can be used for wireless communications, e.g., using WLAN, Bluetooth, and/or cellular communications.

As described herein, wireless node 107 can include hardware and software components for implementing embodiments of this disclosure. For example, one or more components of the wireless communication circuitry 430 (e.g., Wi-Fi Logic 432) of the wireless node 107 can be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

### Service Periods

Some 802.11 specifications can include methods for handling of various service periods by access points. During a service period (SP) a set of STAs can be served and outside of the service the STAs can go to sleep modes. The attributes of such SPs can be agreed between the AP and the STA in a framework known as target-wake-time (TWT).

Recently the SP concept has been updated to accommodate peer-to-peer (P2P) activities, where during a P2P TWT SP the STA can exercise its P2P activities. During a P2P TWT SP, the AP can be aware that the STA is unavailable for infrastructure activities (e.g., WLAN communication with the AP).

It will be appreciated that the term SP is used differently in the context of a P2P TWT SP than in the original TWT SP framework. In the P2P TWT SP framework, the “service” offered by an AP during a P2P TWT SP can be viewed as being award of unavailability of WLAN communication (e.g., due to unavailability of the STA) during the P2P TWT SPs. Thus, the WLAN communication occurs between the P2P TWT SPs, not during the SPs.

Accommodation of P2P frame exchanges along with infrastructure frame exchanges can enhance coexistence of P2P and infrastructure links and can support uninterrupted P2P fame exchanges. This can enhance P2P applications that are affiliated with low-latency traffic. Also, it can enhance frame exchanges on the infrastructure.

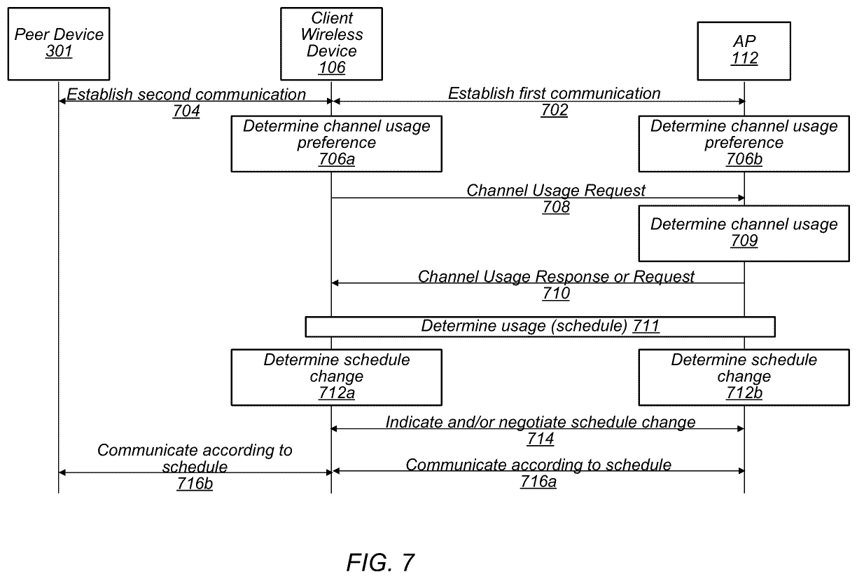

In this disclosure, several methods for enhancing SPs affiliated with P2P activities are proposed. For example, methods of FIGS. 7 and/or 28 can enable greater freedom to the STA and AP to: react to changes to P2P events, e.g., due to jitter in the start or end of P2P frame exchanges; use resources efficiently during P2P events; and address uncertainty in timing, e.g., due to clock drift. These methods can include solutions for a STA that is equipped with multiple radios such as scan radios and for multi-link devices (MLDs).

In some embodiments, a P2P TWT agreement can be a TWT agreement established between a STA and its associated AP. In contrast to non-P2P (e.g., baseline) TWT, the following can be true of P2P TWT agreements: TWT operation rules (10.47 and 26.8) can be ignored when establishing and operating a P2P TWT agreement; TWT element can be used for a P2P TWT agreement only to determine the timing parameters of the P2P TWT schedule; an AP may not send an unsolicited Channel Usage Response frame with a TWT element to a non-AP STA; an AP can consider the non-AP STA to be in power save mode and doze state during P2P TWT SP; and an can AP consider the non-AP STA to be in power save mode and doze state at the start of the P2P TWT SP and back to its original power management mode at the end of the P2P TWT SP unless the AP receives a frame addressed to it from the non-AP STA within the time that overlaps with the P2P TWT SP. A non-AP STA can indicate the duration/lifetime of the requested P2P TWT in a Timeout Interval field of the TIE. A non-AP STA can send a TWT Teardown frame (with same TWT Flow ID and Negotiation Type=0) to teardown a P2P TWT agreement. After lifetime expiry, the AP can send a TWT Teardown frame. A non-AP STA can suspend a P2P TWT agreement by sending a TWT Information frame.

### FIG. 7—Service Period Coordination

Aspects of the method of FIG. 7 can be implemented by one or more AP in communication with a wireless device (e.g., client) and possibly one or more peer device. The AP, wireless device, and/or peer device can be as illustrated in and described with respect to various ones of the Figures herein, or more generally in conjunction with any of the computer circuitry, systems, devices, elements, or components shown in the above Figures, among others, as desired. For example, a processor (and/or other hardware) of such a device can be configured to cause the device to perform any combination of the illustrated method elements and/or other method elements. For example, one or more processors (or processing elements) (e.g., processor(s) 101, 204, 302, 402, 432, 434, 439, 1301, baseband processor(s), processor(s) associated with communication circuitry such as 130, 230, 232, 329, 330, 430, 1330, etc., among various possibilities) can cause a wireless device, STA, UE, and/or AP, or other device to perform such method elements.

Note that while at least some elements of the method of FIG. 7 are described in a manner relating to the use of communication techniques and/or features associated with IEEE and/or 802.11 (e.g., 802.11r, 802.11be, 802.11bX, Wi-Fi 8, etc.) specification documents, such description is not intended to be limiting to the disclosure, and aspects of the method of FIG. 7 can be used in any suitable wireless communication system, as desired.

The methods shown can be used in conjunction with any of the systems, methods, or devices shown in the Figures, among other devices. In various embodiments, some of the method elements shown can be performed concurrently, in a different order than shown, or can be omitted. Additional method elements can also be performed as desired. As shown, this method can operate as follows.

A wireless device 106 (e.g., a client or STA) can establish first communication with a serving AP 112 (702), according to some embodiments. The communication can be wireless communication according to an 802.11 standard on a BSS provided by the AP.

In some embodiments, the wireless device 106 can also establish second communication (704), e.g., with a peer device 301, according to some embodiments. The second communication can be wireless communication according to any of various RATS including an 802.11 standard, Bluetooth, cellular, etc. The second communication can be off-channel communication, i.e., communication on one or more channel(s) that do not overlap with the channel(s) of the BSS provided by the AP. In some embodiments, the channel can belong to the same wireless spectrum or to a different wireless spectrum, e.g., licensed or unlicensed spectrum. The second communication can be P2P communication, e.g., a STA-to-STA link between tunneled direct link setup (TDLS) peer STAs in an infrastructure BSS or between STAs in a non-infrastructure BSS. In some embodiments, the second communication may not be with a peer device, but can be with a different wireless network (e.g., with a cellular base station, among various possibilities). It will be appreciated that the second communication can or may not use some of the same hardware of the wireless device that the wireless device uses for the first communication. The second communication (even if it does not use common hardware with the first communication) can add to in-device coexistence interference (e.g., due to leakage between hardware components.

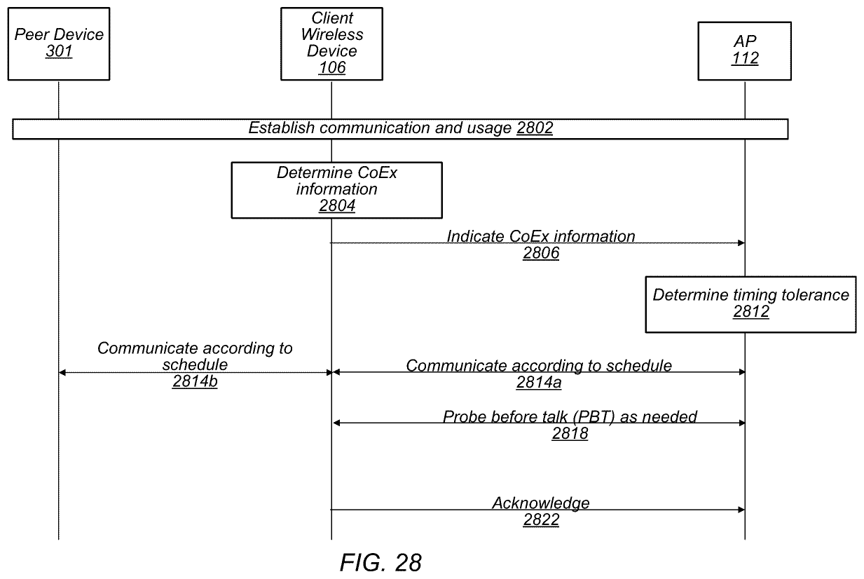

At some times or under some circumstances, it can be possible for the second communication to cause coexistence interference with the first communication with the AP or otherwise reduce the availability of the wireless device for communication with the AP (e.g., in the uplink and/or downlink direction). Accordingly, techniques of FIG. 7 and/or FIG. 28 can reduce, avoid, or mitigate such interference.

It will be appreciated that the second communication can be established at any time, e.g., prior to 702, concurrently with 702, after 702, or even after other steps (e.g., after 706a or after 710, etc.).

The wireless device can determine a channel usage preference for the first communication with the AP (706a), according to some embodiments. For example, the channel usage preference can include a preference for one or more times when the wireless device can have reduced availability for communication with the AP.

The wireless device can determine the channel usage preference based on the second communication. For example, the determination can be based on past and/or expected timing, duration, resources, traffic type(s) and/or other characteristics of the second communication. In the case that 706a occurs prior to 704, the determination can be based on expected or planned characteristics.

The AP 112 can determine a channel usage preference for the first communication with the wireless device (706b), according to some embodiments.

For example, the channel usage preference can include a preference for one or more times when the AP can have reduced availability for communication with the wireless device. This can be particularly relevant in the case that the AP is a soft-AP. The term soft-AP (e.g., a mobile AP) can refer to a device (such as a smartphone) temporarily acting as an AP even though the device can be designed to (e.g., primarily) serve other purposes. In other words, a soft-AP can be an AP that provides a noninfrastructure BSS. For example, such a soft-AP can use the P2P TWT framework to establish SPs during which the mobile AP has reduced availability for communication with its associated STAs. The established SPs can be used by the soft-AP based on the use cases. In one use case, the SPs can be used for P2P frame exchanges that the soft-AP has. In another use case, the SPs can be used to handle in-device coexistence events, e.g., while the soft-AP performs cellular communication. Thus, the AP can determine a preference for reduced availability times.

It will be appreciated that one or both of 706a and/or 706b can be omitted, according to some embodiments. For example, in the case that the AP is not a soft-AP, the AP may not have any times of reduced availability for communicating with STAs (note, this is not to say that congestion cannot or does not occur, but that the AP can be fully dedicated to providing the BSS for the STAs). Thus, 706b can be omitted. Similarly, in the case that a wireless device does not have coexistence events (e.g., 704 is omitted and no second communication occurs), the wireless device may not have periods of reduced availability. Thus, 706a can be omitted. Other examples of these cases are possible.

The wireless device can transmit an indication of its channel usage preference to the AP (708), according to some embodiments. For example, the wireless device can transmit a channel usage request frame as illustrated in FIG. 24 and/or FIG. 27, among various possibilities. A channel usage request frame can be sent by a wireless device to the AP to request specified channel usage. A channel usage request frame for P2P use can include the P2P indication (e.g., value 3) in the usage mode illustrated in FIG. 26, which can be included in the channel usage elements field as illustrated in FIG. 27. In particular, the TWT elements and/or timeout interval element (TIE) (shown in FIG. 27) can indicate the requested timing (e.g., duration, period, start time, etc. of the requested SPs). The channel usage information can include a set of channels (e.g., provided by the AP) for operation of non-infrastructure communication and/or off-channel direct link(s). The channel usage information provided by an AP can advise the wireless device on how to coexist with the infrastructure network (e.g., the 802.11 BSS provided by the AP).

Note, 708 can be omitted, e.g., in the case that 706a is omitted, among various possibilities.

The AP can determine a channel usage (709), according to some embodiments. The response can be based on the wireless devices request (e.g., 708) (if any), its own preferences (e.g., 706b) (if any), and/or other information (e.g., other traffic on the BSS). For example, the AP can determine duration, period, starting time, channel(s), link(s), and/or other characteristics for a series of TWT SPs for the wireless device.

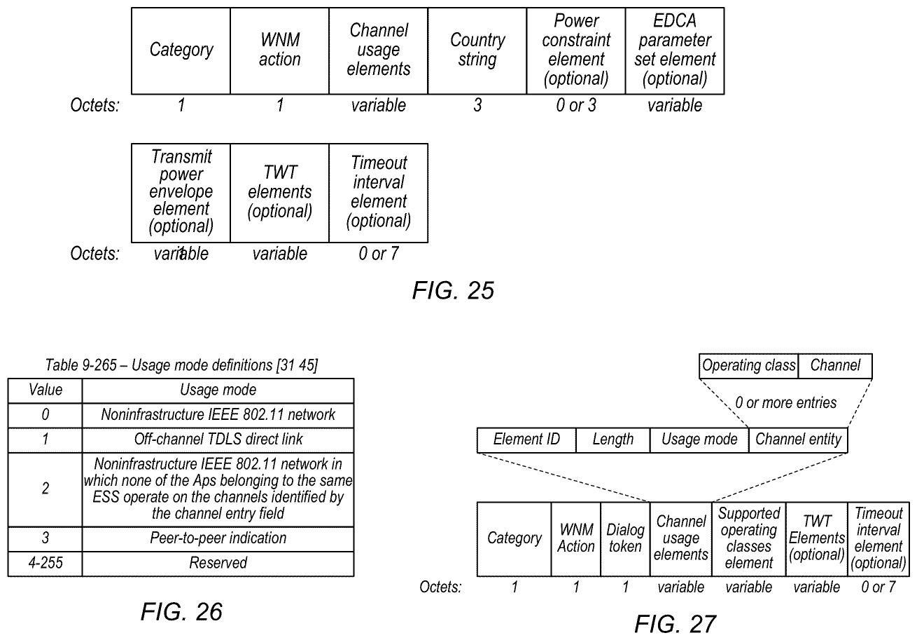

The AP can transmit a channel usage message to the wireless device (710), according to some embodiments. For example, the AP can transmit a channel usage response to a channel usage request (e.g., 708) from the wireless device. FIG. 25 illustrates an example channel usage response, according to some embodiments. In particular, the TWT elements can indicated the accepted timing (e.g., duration, period, start time, etc. of the SPs).

In the case that 706a and 708 are omitted, the AP can transmit a channel usage request to the wireless device based on its own preferences (e.g., 706b).

The wireless device can receive the message (e.g., 710). In some embodiments, if the wireless device has not requested channel usage information, it can discard an unsolicited group addressed channel usage response frame. In some embodiments, the wireless device can respond to the message with a channel usage response frame if the message is a channel usage request frame.

Based on the channel usage request and/or response frames, the wireless device and AP can have a common understanding of the channel usage information (e.g., schedule of SPs) (711), according to some embodiments. This understanding can be or include a (e.g., P2P) TWT agreement. In other words, based on the negotiations of 708-710, the AP and wireless device can each determine the channel usage information for the wireless device, which can include a schedule of service periods where reduced availability for communication of one or both the wireless device and/or AP is expected. It will be appreciated that “reduced availability” can refer to non-availability (e.g., the wireless device tuning away from the channel(s) of the BSS during the SP) or some form of limited availability (e.g., such as monitoring the channel(s) with a secondary radio such as a scan radio, being available for transmission and/or reception with a lower sensitivity level or lower throughput, etc.). For example, the wireless device can use the channel usage information: as part of channel selection for the second communication, for determining transmit power for the second communication, for determining enhanced distributed channel access (EDCA) parameters for the second communication, and/or for determining classification of frames for the second communication.

It will be appreciated that any number of parameters for the channel usage and/or P2P TWT agreement can be negotiated, agreed, and/or determined in 708, 710, and/or 711. For example, a threshold for when (e.g., how far in advance of a next SP) the next SP can be started early vs a new (e.g., unplanned) SP can be initiated can be determined. Similarly, the interpretation of a duration of a modified SP (e.g., whether a duration is kept constant or shortened/extended for an SP that is started late/early) can be determined. Other parameters can also be determined as desired.

Note that any amount of time and/or any number of SPs can occur between 711 and 712a/712b.

The wireless device can determine a desired change in the schedule for communication with the AP (712a), according to some embodiments. The determination can be based on a change in the second communication (e.g., with peer device 301, another network, etc.) and/or other coexistence concerns. Similarly, the determination can be based on a change in planned communication with the AP. Both can be considered together for the determination, according to some embodiments. As some examples, the wireless device can determine that an SP may: end early (e.g., due to higher priority traffic with the AP and/or clearing buffers for the second communication); start early (e.g., due to higher priority traffic for the second communication); start late (e.g., due to higher priority traffic with the AP and/or clear buffers for the second communication); end late (e.g., due to remaining buffered traffic for the second communication); and/or be skipped (e.g., due to higher priority traffic with the AP and/or clear buffers for the second communication), among various possibilities. Similarly, an SP can be added (e.g., due to urgent buffered traffic for the second communication).

The AP can determine a desired change in the schedule for communication with the wireless device (712b), according to some embodiments. The determination can be based on traffic with the wireless device (e.g., the AP can be aware of traffic with a low latency target to/from the wireless device), traffic with other STAs of the BSS, and/or other activities or constraints of the AP (e.g., if the AP is a soft-AP, it can desire more and/or longer SPs based on battery, coexistence interference, etc.).

It will be appreciated that either of 712a or 712b can be omitted. For example, in many cases only one can occur (e.g., as only one device can desire a change).

Moreover, both 712a and 712b can be omitted under circumstances when neither device desires a change. In that case, the schedule determined in 711 can be used without modification.

The wireless device and/or AP can exchange one or more messages to indicate and/or negotiate the change in the schedule (714), according to some embodiments. For example, if the wireless device determines a change (e.g., 712a), it can send a frame to the AP to indicate the change; if the AP determines a change (e.g., 712b), it can send a frame to the wireless device to indicate the change. In some embodiments, a single message with the indication can complete the negotiation. In other cases, additional messages can be used (e.g., in response to the notification the AP or wireless device can transmit a response to acknowledge, approve, or possibly reject or modify the indicated change).

The wireless device and AP can communicate according to the schedule (e.g., as modified) (716a), according to some embodiments. For example, outside of the SP(s) (e.g., as modified) the wireless device and AP can exchange uplink and/or downlink data using up to the full capacity of the wireless link(s) between them. During the SP(s) (e.g., as modified) the wireless device and AP may not exchange data (e.g., in the case of complete unavailability) or can exchange data or monitor the link(s) in some more limited way (e.g., in the case that the availability is reduced, but not eliminated during the SP(s)).

In the case that the AP is a soft-AP, the AP can perform communication with other devices (e.g., P2P, with a cellular network, etc.), during the SP(s) (e.g., as modified), thus reducing its availability.

Similarly, the wireless device can perform the second communication (e.g., with a peer device 301, other network, etc.) according to the schedule (e.g., as modified) (716b), according to some embodiments. For example, outside of the SP(s) (e.g., as modified) the wireless device can avoid communication that would interfere with the first communication with the AP. During the SP(s) (e.g., as modified) the wireless device can perform the second communication and/or otherwise reduce its availability for communication with the AP.

The following examples provide additional illustrations of potential, non-limiting examples of the method of FIG. 7.

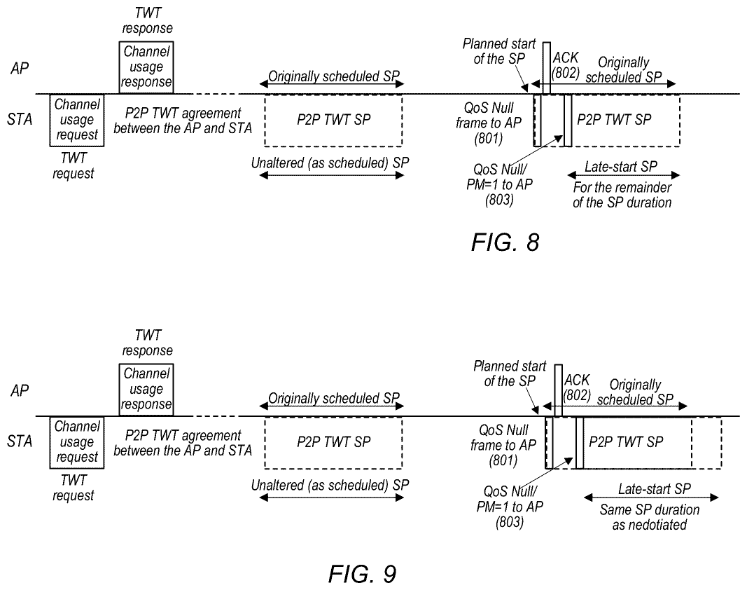

Based on the latest 802.11 baseline specification (e.g., that is captured in 802.11me specification), an AP can assumes that the STA (e.g., wireless device) is in a power save mode during a P2P TWT SP “unless the AP receives a frame addressed to it from the non-AP STA within the time that overlaps with the peer-to-peer TWT SP”. Therefore if the wireless device sends a frame (e.g. quality of service (QOS) Null) to the AP at the beginning of a scheduled P2P TWT SP, the AP can assume that the wireless device has canceled the SP instance, and the wireless device is not in power save mode. FIGS. 8-11 illustrate methods where the wireless device can go into the P2P TWT SP at a later point during the said P2P TWT SP, according to some embodiments.

For example, if the time left during a current P2P TWT SP is greater than a threshold, the wireless device can set power management (PM)=1 in the last data frame sent to the AP (or can sent a QoS Null with PM=1) to indicate to the AP that the wireless device would be in power save (PS) mode until the end of the current (as negotiated) P2P TWT SP. This example is illustrated in FIG. 8, according to some embodiments. As shown, the wireless device and AP can negotiate a TWT agreement via a request (e.g., as in 708) and response (e.g., as in 710) process and determine a schedule (e.g., as in 711). Any number of unaltered SPs can occur as originally scheduled. In response to a determination (e.g., 712a) that an SP can start late, the wireless device can transmit a message (801) (e.g., such as a QoS null with PM=0) to the AP indicating that it is available at the beginning of the SP. The AP can acknowledge (802). The wireless device can transmit a message (803) (e.g., such as a QoS null with PM=1) to the AP indicating that it is not available or has reduced availability for the remainder of the SP. Thus, in the case of FIG. 8, the SP can start late and have a reduced duration, thus ending at the originally scheduled end time.

FIG. 9 illustrates an example of a late start and late ending, thus maintaining the originally scheduled duration (shifted later). As in FIG. 8, the wireless device can indicate availability (801) and receive acknowledgement (802). Then, the wireless device can set PM=1 (803) in the last data frame sent to the AP (or can send a QoS Null with PM=1) to indicate to the AP that the wireless device would start its P2P TWT SP after the frame (e.g., 803) and would continue for the same duration.

The selection between the variations in FIGS. 8 and 9 can occur per some indication within the P2P TWT negotiation. For example, either the AP or wireless device can indicate which interpretation will be used for the P2P TWT agreement. Alternatively, this can be set in standards.

Note that the use and functionality of PM bit in FIGS. 8 and 9 can be associated with an ongoing P2P TWT agreement. The wireless device can send a frame with PM=0 to the AP to indicate that the wireless device is out of the doze state. Alternatively, a new behavior for the AP can be to assume that the wireless device is out of doze state after the end of the P2P TWT SP.

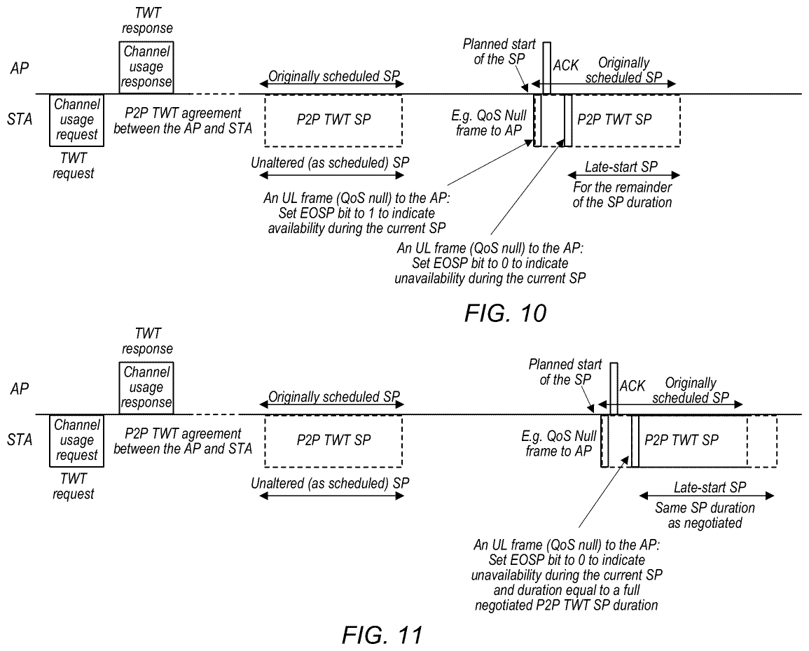

FIG. 10 and FIG. 11 show similar examples to FIG. 8 and FIG. 9, respectively, using a different signaling approach. FIGS. 10 and 11 illustrate another way for a wireless device to signal the AP of the late start of a P2P TWT SP, according to some embodiments. As shown, the wireless device can send a frame within which it utilizes an End of Service Period (EOSP) field. A first value (e.g., UL EOSP=1) can indicate that the wireless device will be available during the ongoing P2P TWT SP, while a second value (e.g., UL EOSP=0) can indicate that the wireless device will not be available during the remainder of the P2P TWT SP. This example is shown in FIG. 10. Alternatively (per signaling during establishment of a P2P TWT agreement), the second value (e.g., UL EOSP=0) can mean the wireless device will not be available during the current SP, where the duration of the SP would be equal to a full negotiated P2P TWT SP duration. This example is shown in FIG. 11.

Note: the EOSP bit (in QoS Control filed in MAC header as shown in FIG. 12) can be reserved for STA according to current 802.11 standards. The methods of FIGS. 10-11 can allow a wireless device to use this bit to indicate above behaviors during the time that there is a P2P TWT agreement between the wireless device and its associated AP.

It will be appreciated that EOSP and QoS Null can be used in combination. For example, a first QoS Null with PM set to 0 transmitted during a first service period of reduced availability can indicate a late start of the SP. A second QoS Null transmitted after the first QoS Null can indicate that the SP is start of the reduced availability period. The second QoS Null can comprises an EOSP field set to one of a first value or a second value, to indicate whether the SP will end as previously scheduled of will extend for a complete duration. For example, the first value can indicate reduced availability for communication with the AP during a remainder of the first service period according to a current end time and the second value can indicate reduced availability for communication with the AP during a complete duration of the first service period beginning from a time of the second QoS Null.

FIG. 13 and FIG. 14 illustrate examples of an early start for an SP, according to some embodiments. When the wireless device desires to start an SP early (e.g., due to data for the second communication) and a scheduled start-time of a next upcoming SP is less than a threshold from the desired start-time, the wireless device can initiate the SP early. For example, the wireless device can send a (QOS Null) data frame which sets PM=1, indicating early start of the next/upcoming SP. Note that EOSP can be used to initiate the SP early, instead of the PM (similar to the discussion above with respect to FIGS. 10-11).

Similar to FIGS. 8-11, the duration of early started SP can be extended, or the normal duration can be used and shifted earlier. FIG. 13 illustrates the case that the SP is started earlier and is extended to end at the previously scheduled end time. In this case, the AP can assume the wireless device is unavailable until the end of the upcoming P2P TWT SP, unless the AP receives a frame addressed to it from the non-AP wireless device within the time that overlaps with the peer-to-peer TWT SP. FIG. 14 illustrates the case that the SP is started earlier and the normal duration is used, resulting in an early end time. Whether the duration is extended of the SP is ended early can be negotiated or set in standards. Further, different EOSP values can be used to indicate the different possibilities (e.g., first value=extended duration; second value=early end)

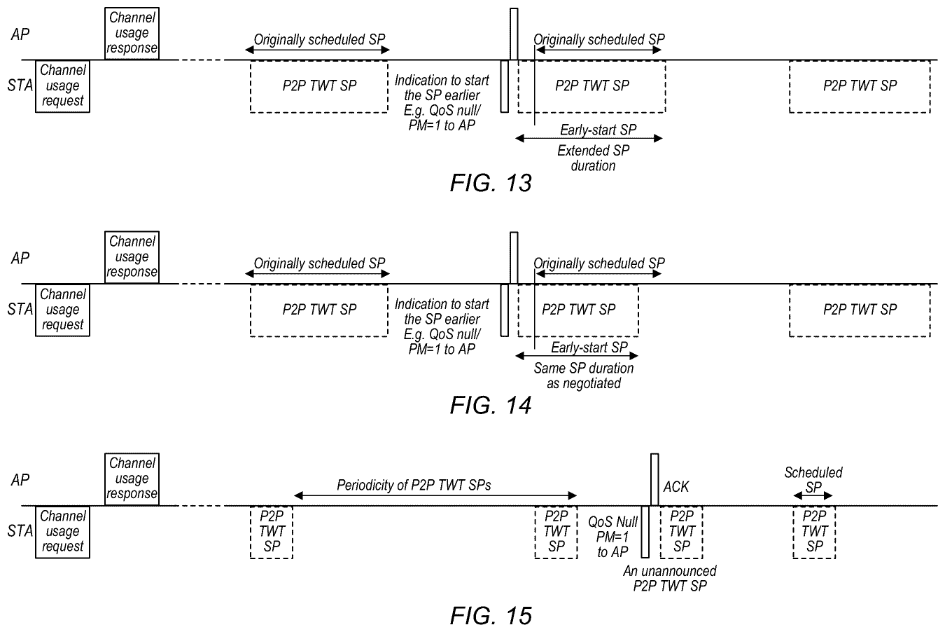

FIG. 15 illustrates an added SP instance, according to some embodiments. When the wireless device desires to start an SP early (e.g., due to data for the second communication) and a scheduled start-time of a next upcoming SP is greater than a threshold from the desired start-time, the wireless device can initiate an unplanned or not-previously announced SP instance. The wireless device can send a (QOS Null) data frame which sets PM=1 (or EOSP to an appropriate value), indicating early start of an SP. The AP can assume the wireless device has initiated a P2P TWT SP with the same attributes (e.g., duration) of the same negotiated P2P TWT, and that the wireless device is unavailable until the end of the SP that has just been initiated.

If the wireless device has negotiated multiple P2P TWT agreements with the AP, the duration of the unannounced TWT SP can be set according to a primary agreement or as negotiated during 708-711.

Note that the use and functionality of PM bit here is alongside an ongoing P2P TWT agreement. The wireless device can send a frame with PM=0 to the AP to indicate that the wireless device is out of the doze state. Alternatively, a new behavior for the AP is to assume that the wireless device is out of doze state after the end of the P2P TWT SP.

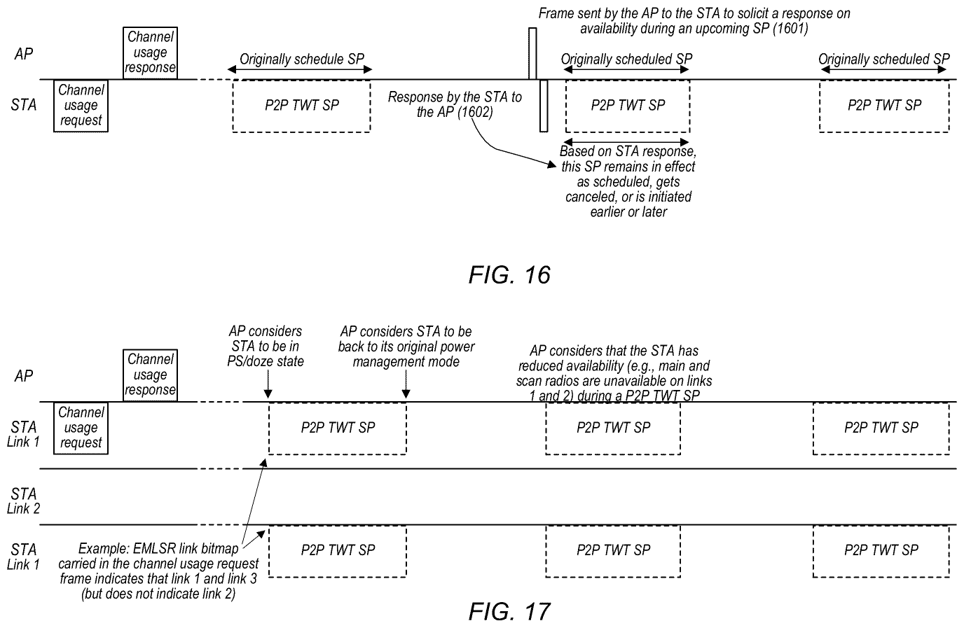

FIG. 16 illustrates AP suspension of a P2P TWT SP, in consultation with the wireless device, according to some embodiments. An AP that has an ongoing P2P TWT agreement with a SP, and has one or multiple traffic identifiers (TID) with low-latency attributes, can use some signaling to check whether the wireless device is available during an upcoming SP during which the AP can utilize the SP to send low latency and/or other data frames to the wireless device. In other words, if the AP knows there is traffic with a low latency target to/from the wireless device, the AP can ask if the AP will skip or reduce one or more SP to receive/transmit the low latency traffic. The following describes such signaling between the AP and the wireless device. The AP can send a frame (1601) to check whether the wireless device is available during the coming P2P TWT SP. This frame can include details such as direction, type, amount, and/or timing of the low latency traffic. The wireless device can consider this information and its other priorities (e.g., second communication 704) and can generate a response (1602) to indicate to the AP whether the wireless device decides to execute the SP as scheduled, go to the SP late (e.g., after the frame(s) for the low latency traffic), go to the SP early and end the SP early (e.g., before the frame(s) for the low latency traffic), skip the upcoming SP instance (e.g., to be available to transmit or receive the urgent frame(s)). Based on the response (1602), the AP can know when the P2P TWT SP starts (e.g., whether/when during the upcoming SP the wireless device can be available).

The DL frame sent by the AP which carries the signaling (1601) can be: any data frame, a QOS null frame, basic trigger frame or buffer status report poll (BSRP) trigger frame, among various possibilities. The wireless device can respond (e.g., with any data frame or QoS Null frame) to the above-mentioned frame by the AP and to indicate: the wireless device will be available during at least a portion of the upcoming P2P SP, the wireless device will not be available during the upcoming P2P SP, or the wireless device will not be available from transmission of this frame until the end of the P2P SP. Any of the above choices can be signaled by the wireless device via one of the following fields (which would be present in any data frame or QoS Null frame that the wireless device sends in response to the AP): A-Control field, or a set of two bits in MAC header (e.g., the set comprising: the EOSP bit and a more data bit).

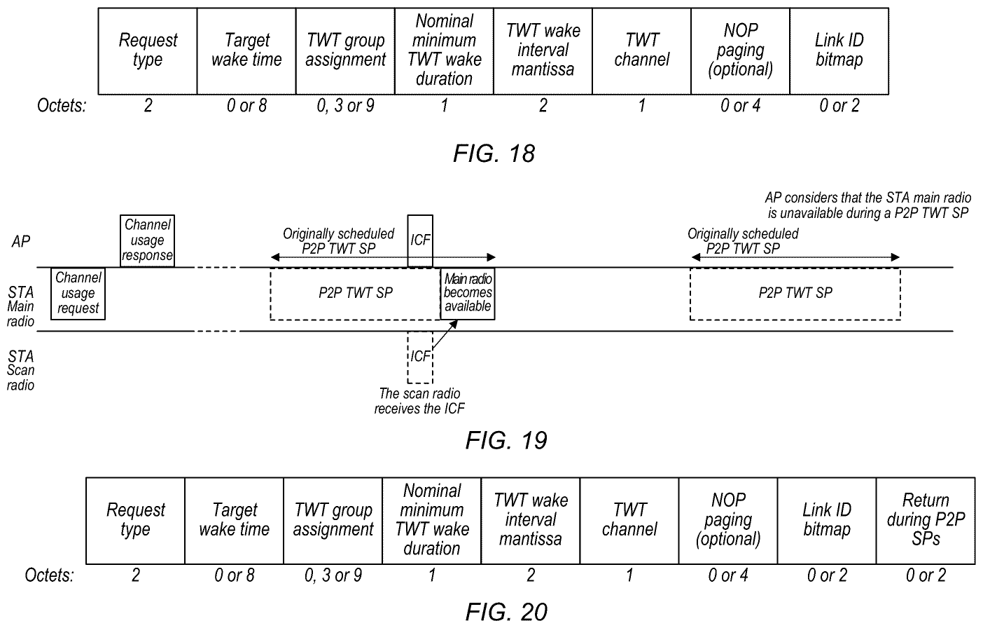

FIG. 17 illustrates the applicability of P2P TWT (including methods of FIG. 7) to MLD and enhanced multilink single radio (EMLSR), according to some embodiments. A P2P TWT agreement (e.g., as determined in 708, 710, and 711) can be applicable to the links of a an MLD wireless device selected for the agreement. For example, the wireless device can decide that a P2P TWT agreement applies to all or a subset of the links. To signal the selected link(s), the wireless device can utilize the signaling in “EML Operating Mode Notification” which can carry (e.g., new) field which indicates whether the TWT agreement (regardless of whether it is a P2P TWT agreement or other type of TWT agreement) is applied to all EMLSR links, or just the signaled link. Further a Channel Usage Request can carry a EMLSR Link Bitmap (e.g., the “Link ID Bitmap of FIG. 18, which can correspond to the “EML Operating Mode Notification”) indicating which links use the P2P TWT agreement.

The wireless device can use an alternative signaling approach. For example, the P2P TWT specific signaling could be on P2P TWT Setup frames (see e.g., FIGS. 24 and 25, the channel usage request and response frames can be referred to as the P2P TWT Setup frames). Thus, during establishment of a P2P TWT agreement (e.g., 708, 710 and 711), the requesting wireless device can include the Link ID Bitmap in the Individual TWT Parameter Set where in the Link ID Bitmap, the wireless device identifies the links that are also part of the P2P TWT request/agreement. For example, a value of 1 in bit position i of the Link Bitmap subfield can indicate that the TWT element (of the P2P TWT request) sent by a wireless device affiliated with an MLD applies to the link associated with the link ID i.

In the example of FIG. 17, the P2P TWT agreement set in the request and response (e.g., 708 & 710) can apply to links 1 and 3, but not link 2. In other words, during the SPs, the AP can treat the wireless device as in a reduced availability state (such as power save (PS) or doze) on links 1 and 2. Other examples are possible.

In some embodiments, the wireless device can have only one radio to use for the first communication with the AP. In other cases, wireless device can have more than one radio to use for the first communication with the AP. For example, the wireless device can have a main (e.g., full capability) radio and a secondary (e.g., lower capability radio such as a scan radio which can be receive only).

In some embodiments, the main and secondary radios can go to the agreed P2P TWT SPS simultaneously. For example, this can be the case illustrated in FIGS. 8-11 and 13-17. One use case for this approach can include that the SP is used for P2P on a different channel. Thus, there can same start times and end times of SP for both main and secondary radios.

However, it will be appreciated that the method of FIG. 7 (including the examples illustrated in FIGS. 8-11 and 13-17) are not limited in this way. In other words, it can be the case that a main radio goes to a the agreed P2P TWT SP, but a secondary radio does not (or does so beginning and/or ending at a different time). One use case for this approach can be that the SP is used for a coexistence event (where the main radio is inactive due to coexistence with other radios). Thus, the secondary radio can remain active for the first communication in case the AP has pending DL data for the wireless device.

FIG. 19 illustrates a secondary radio being used to recall a main radio, according to some embodiments. Although FIG. 19 is illustrated with MLDs, it will be appreciated that single link devices can perform similar techniques. The wireless device main radio can go to a P2P TWT SP as planned by a P2P TWT agreement, however, the secondary radio can be available for at least part of the SP. The AP can be aware of this availability of the secondary radio. If the AP decides to inform the wireless device of an event of interest (e.g., arrival of low-latency traffic etc. during an SP) the AP can first send an initial control frame (ICF) to the wireless device via the second radio. Thus, the wireless device can activate the main radio for the first communication for some or all of the remainder of the SP. In other words, the second radio can inform the main radio and the main radio becomes available (and would react to the ICF transmission accordingly). The ICF can indicate the type of traffic (e.g., application, UL vs DL, amount, etc.).

To enable the types of exchanges as described above with regard to FIG. 19, during the set up of the P2P TWT agreement (e.g., 708, 710, 711), the wireless device can indicate to the AP: (1) whether the EMLSR radio(s) at identified links are available during P2P TWT agreements (defined in the Link ID Bitmap, as in FIG. 18), and (2) whether the wireless device (main radio at the main link identified with its Link ID) is available to come back out of P2P TWT SPs (in the “Return during P2P SPs” subfield shown in FIG. 20). The “Return during P2P SPs” subfield duration can be 0 or 2 octets and, if present, the 1 at bit position i, can indicate that the main radio can be available to come out of a P2P TWT SP upon reception of an ICF at link i (as described in the procedure in this slide), otherwise it is set to 0. If the main radio is not available to come out of P2P TWT SP, then either “Return during P2P SPs” subfield may not be present, or if present, it has zero value in each bit position.

In some embodiments, after the wireless device that indicates capability to return the main radio to the first communication it can still determine not to return the main radio in response to an ICF (e.g., based on other activities of the wireless device.

The “Return during P2P SPs” can be present even if the “Link ID bitmap” is not, e.g., in single link cases, etc.

As noted above, a soft-AP can set up P2P TWT SPs to establish times for other activities and/or limit the amount of time/resources that it spends in the first communication. FIG. 21 illustrates a frame exchange for a soft-AP to set up P2P TWT SPs, according to some embodiments. Note, a soft-AP can be a mobile AP.

As one possibility, the AP (e.g. a soft-AP) can send a Channel Usage Request frame with a TWT Element that includes a Broadcast (BC) TWT Parameter Set. The BC TWT parameters can apply to any wireless device (e.g., STA) in the BSS. A wireless device that is associated with the AP, upon receiving above Channel Usage Request frame can take into account the BC TWT agreement. The wireless device can send Channel Usage Response frame to the AP where the TWT Element includes the same values as the previously received TWT Element in the Channel Usage Request frame.

Alternatively, the (soft) AP can send a Channel Usage Response frame to its associated wireless devices without any prior Channel Usage Request frame sent by any of the wireless device. In the Channel Usage Request frame that the (soft or mobile AP) sends to its associated wireless devices, the TWT Element can include a BC TWT Parameter Set.

The TWT Element in the Channel Usage Request/Response frame can carry a TWT Element that includes a Broadcast TWT Parameter Set.

Note that in FIG. 21 (and other figures), uplink and downlink frames can be exchanged at any time between the SPs.

In some embodiments, a BC P2P TWT set by a (soft) AP can serve to tell all the associated STAs to the soft-AP that the AP is unavailable during these SPs due to: 1) the soft-AP, also being a STA, has P2P link with another STA, and/or 2) the soft-AP turns off power periodically to save power. Hence the broadcast nature of this (P2P TWT) SP.

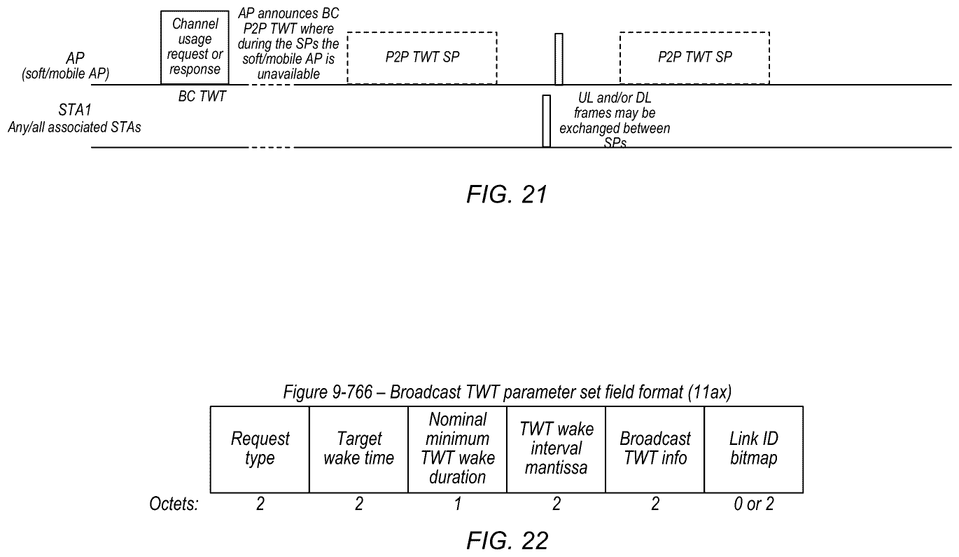

In some embodiments, the BC TWT Parameter Set can include a Link ID Bitmap, as shown in FIG. 22, according to some embodiments. The Link ID Bitmap can indicate which links (as identified by the soft/mobile AP) are affected under the P2P TWT agreement. If no Link ID Bitmap exists, or if all the links are affected by the P2P TWT agreement, then during the SPs, the soft/mobile-AP can be considered unavailable. If there is a link that is not affected by the P2P TWT agreement, the link can be an EMLSR link (of the mobile/soft-AP). If an EMLSR link is identified as not being affected by the P2P TWT agreement, the wireless devices that are affiliated with the soft/mobile AP can transmit, during the SPs, an initial control frame (ICF) to the EMLSR link. Once the ICF is received by the EMLSR radio, the soft/mobile AP can choose to come out of the P2P TWT SP to accommodate the need of the wireless device that has sent the ICF.

Different prioritization schemes for different types of SPs can be possible. In other words, the relation between normal SPs and TWT SPs can be set in standards and/or negotiated in a TWT agreement (e.g., 708, 710, 711).

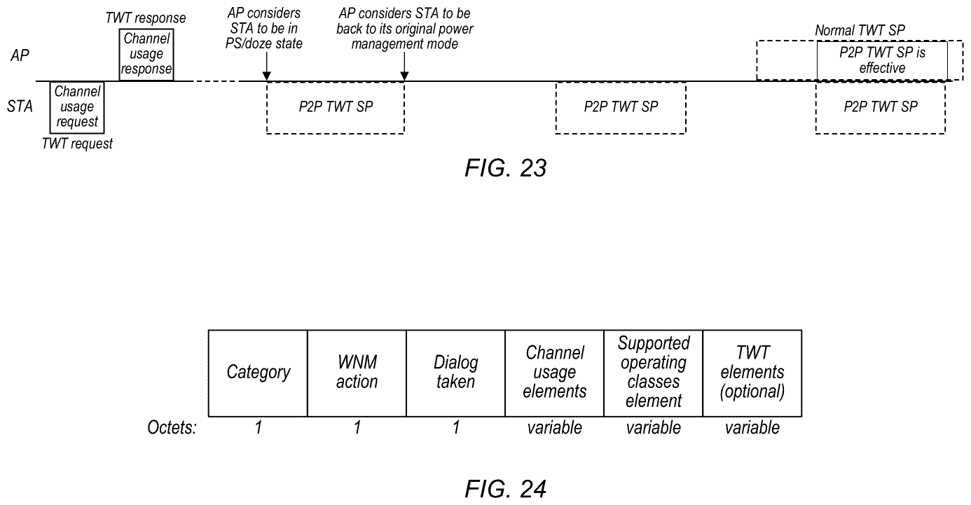

In some embodiments, a P2P TWT SP can have priority, as shown in FIG. 23, according to some embodiments. If two SPs are overlapped the AP can assume wireless device unavailability during a TWT SP regardless if the TWT SP partially/fully overlaps with another a SP of another TWT agreement. Thus, the AP can resume scheduled transmission for a regular TWT SP, after the end of a TWT SP.

It will be appreciated that the reverse case (e.g., priority to the normal SP) is also possible.

### FIG. 28—Coexistence Information

FIG. 28 illustrates a method for exchanging and using coexistence information, according to some embodiments. In some embodiments, the methods of FIGS. 7 and 28 can be combined. However, it is also possible that methods according to either FIG. 28 or FIG. 7 can be performed independently of the other, according to some embodiments.

Aspects of the method of FIG. 28 can be implemented by one or more AP in communication with a wireless device (e.g., client) and possibly one or more peer device. The AP, wireless device, and/or peer device can be as illustrated in and described with respect to various ones of the Figures herein, or more generally in conjunction with any of the computer circuitry, systems, devices, elements, or components shown in the above Figures, among others, as desired. For example, a processor (and/or other hardware) of such a device can be configured to cause the device to perform any combination of the illustrated method elements and/or other method elements. For example, one or more processors (or processing elements) (e.g., processor(s) 101, 204, 302, 402, 432, 434, 439, 1301, baseband processor(s), processor(s) associated with communication circuitry such as 130, 230, 232, 329, 330, 430, 1330, etc., among various possibilities) can cause a wireless device, STA, UE, and/or AP, or other device to perform such method elements.

Note that while at least some elements of the method of FIG. 28 are described in a manner relating to the use of communication techniques and/or features associated with IEEE and/or 802.11 (e.g., 802.11r, 802.11bc, 802.11bX, Wi-Fi 8, etc.) specification documents, such description is not intended to be limiting to the disclosure, and aspects of the method of FIG. 28 can be used in any suitable wireless communication system, as desired.

The methods shown can be used in conjunction with any of the systems, methods, or devices shown in the Figures, among other devices. In various embodiments, some of the method elements shown can be performed concurrently, in a different order than shown, or can be omitted. Additional method elements can also be performed as desired. As shown, this method can operate as follows.

As generally shown at 2802, the wireless device and AP (and possibly peer device 301) can establish communication and determine usage, similar to 702-710 of FIG. 7. First communication between a wireless device and AP can be established as discussed above with regard to 702, according to some embodiments. In some embodiments, second communication can be established as discussed above with regard to 704, according to some embodiments. However, it will be appreciated that the second communication can or may not be with a peer device. Further, the wireless device can determine a channel usage preference (as discussed regarding 706a) and/or the AP can determine a channel usage preference (as discussed regarding 706b), according to some embodiments. wireless device and AP can exchange messages about their preferences as in 708 and/or 710, according to some embodiments. It will be appreciated that the discussion of 702-710 above can similarly apply to FIG. 28, according to some embodiments.

In addition to or instead of the information of 706a, the wireless device can determine other coexistence information (2804), according to some embodiments. The coexistence information can include any or all of: information related to clock drift; information related to an interference level of a co-located radio; detailed timing information of one or more coexistence event; or channel mapping information.

In some embodiments, the information related to clock drift can include an expected rate of drift of the first communication relative to the second communication. The information can include an uncertainty window due to clock drift (e.g., an amount of time at the beginning and/or end of an SP when it can be uncertain whether the wireless device is available).

In some embodiments, the information related to an interference level of a co-located radio can include determining a sensitivity of one or more radios used for the first communication during relevant coexistence events. For example, the wireless device can determine how sensitive the radio(s) used for WLAN can be during UL and/or DL periods of the second communication. The wireless device can determine limits for performing UL and/or DL communication for the first communication during such periods of UL and/or DL second communication. The information can include Tx power limits, Rx sensitivity, etc.

As one example of the interference level information, it can be the case that in certain co-ex event, the isolation between WiFi and co-located radio (CoRa) may not be enough to fully support concurrent operation, but can still sustain the wifi downlink at a lower rate. In other words, if limited concurrent WiFi::CoRa==RX::TX is allowed, then the CoRa's activities can de-sensitize the WiFi RX sensitivity. However, particularly if the (e.g., CoRa) transmission rate is lowered, then the first communication (e.g., WiFi) can still work. Thus, there can be, no need to stop the first communication completely. Accordingly, the interference level information can describe how sensitive the WiFi radio can be during the co-ex event(s).

In some embodiments, the detailed timing information of one or more coexistence event can include determining UL and/or DL timing of the second communication. For example, the wireless device can determine that during a period of second communication, one or more portions can be used for Tx, one or more portions can be used for Rx, and/or one or more portions can be used for both Tx and Rx (or can be flexible). Such timing information can be based on a fixed traffic pattern, known information about upcoming traffic, etc.

In some embodiments, the channel mapping information can include information about the frequencies used by the second communication.

The wireless device can transmit one or more messages indicating the coexistence information to the AP (2806), according to some embodiments. As one possibility, a coexistence information element for p2p TWT session with a TWT element, can be used to convey the Coexistence information. For example, the information element can include the following: uncertainty window due to clock drift; co-located radio interference level; fine-grained timing info of co-ex event (e.g., a single SP could be divided into multiple segments, the fixed traffic pattern of the co-ex event, e.g., the co-ex event always starts with TX with a duration, the following is always RX); and/or channel map information (which can be used for better channel selection, channel puncture or secondary channel usage). In some embodiments, new fields can be added to the TWT element or a replacement form of the TWT element can be standardized to include the coexistence information.

It will be appreciated that 2804 can occur at the same time(s) as 706a or at a different time(s). Similarly, the indication 2806 can be combined with or separate from the indication of 708 (e.g., if 708 occurs).

Further, in addition to or instead of the information of 706b, the AP (e.g., particularly a soft-AP) can determine other coexistence information. The coexistence information can include any or all of: information related to clock drift; information related to an interference level of a co-located radio; detailed timing information of one or more coexistence event; or channel mapping information, as discussed above with respect to 2804. The AP can indicate this information in 710 or otherwise at the same or different time than 2806.

A common understanding of channel usage can be established (e.g., as in 711) prior to 2804/2806 or after 2804/2806. For example, the AP can respond to or acknowledge the coexistence information of 2806, according to some embodiments. In the case that the common understanding of channel usage can be established prior to 2804/2806, that understanding can be modified based on 2804/2806 and any responses from the AP. In reaching the common understanding, the coexistence information can be considered by the wireless device and/or AP. For example, one or more links can be set to use frequencies that reduce or avoid conflicts with the second communication (as indicated in any channel mapping information). Similarly, timing of SPs can be established or modified in view of any timing information. For example, when the AP receives the updated timing information (e.g., start time of the P2P TWT SP, information about clock drift, etc.) from the wireless device 106, the AP can update the future start times of the future SPs accordingly.

The AP can determine timing tolerance parameters (2812), according to some embodiments. Such parameters can be based on clock drift information provided by the wireless device and/or based on standards or default values. The parameters can include determining a duration of an uncertainty window and/or determination of when an uncertainty window can be used. For example, the AP can determine a number of SPs that can occur (e.g., since a most recent timing update) before uncertainty windows are needed. It will be appreciated that the timing tolerance parameters (e.g., 2812), can be part of the common understanding (e.g., the TWT agreement) of 711.

The wireless device and the AP can communicate according to the schedule/TWT agreement (2814a), according to some embodiments. This can be similar to 716a and any/all of the techniques described with respect to 716a can apply. Additional techniques in view of the coexistence information can also be performed for any of the embodiments of FIGS. 7 and 28.

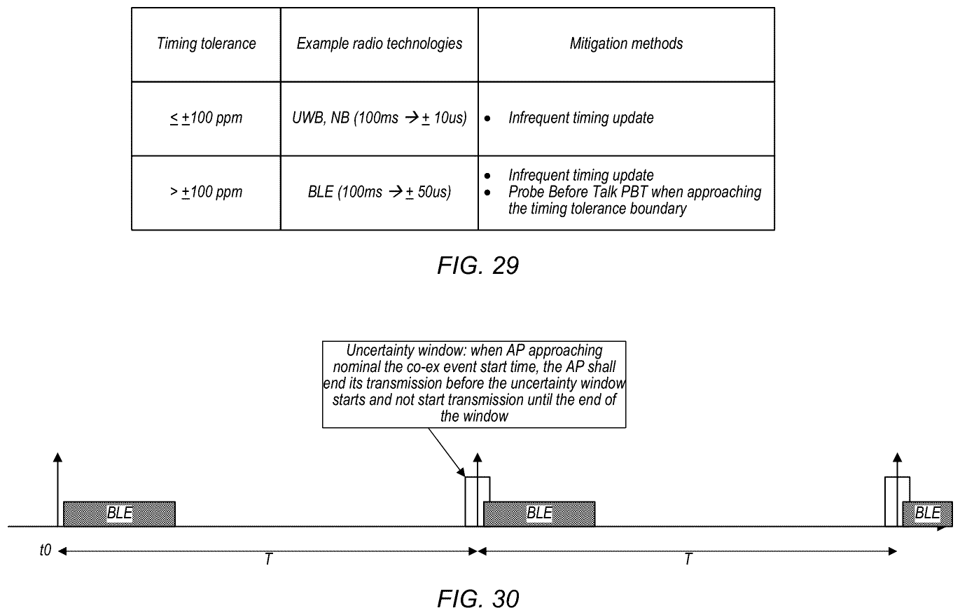

For example, FIG. 29 summarizes clock drift mitigation approaches, according to some embodiments. As shown, if a P2P TWT agreement is used for in-device co-existence events with periodic activities of co-located radios such as (BLE, Narrow Band Assisted (NBA)-ultra-wideband (UWB), LTE, etc.), the clock drift of the co-located radios can cause the coex event start time (TWT SP start time) to drift away from the nominal start time defined by the P2P TWT agreement. Thus, it can be beneficial to update the TWT SP start time as needed or periodically (e.g., for each TWT SP) if the clock drift is small (e.g., ≤±100 parts per million (ppm)). Such updating can incur great overhead when the clock drift is large (e.g., ±500 ppm as can be the case for BLE). To mitigate clock drift, the wireless device can occasionally (e.g., periodically and/or as needed) provide timing update(s) to the AP. Further, the AP can determine tolerance boundaries (e.g., an uncertainty window) and apply Probe Before Talk (PBT) during this uncertainty window (2818), according to some embodiments. The timing update could use TWT information frame, an action frame for clock synchronization, a frame with an A-Control field included in a media access control (MAC) header which can be carried with UL data (if any), or a block-acknowledgement (BA) frame such as a variant of Multi-STA BA frame when responding DL data from the AP, among various possibilities.

For example, if the accumulated clock drift is 50 us, it can be beneficial for the wireless device to tell the AP to adjust the timing (e.g., via an update message). This means that for small drift co-located radios this level of drift can occur around 300 ms. Therefore, the wireless device can send the timing update every 300 ms, which can be considered acceptable overhead. But considering BLE with 500 ppm drift, this level of drift can occur every 60 ms, potentially triggering such an update. This can be 2 frames for each beacon interval, which can be considered excessive overhead (not only for airtime, but also for AP to consider the schedule change this frequently). Accordingly, less frequent updates and use of the PBT/uncertainty window approach can be preferred for large clock drift radios.

FIG. 30 illustrates an uncertainty window, according to some embodiments. As shown, during the uncertainty window prior to an SP (and including the beginning of the SP, according to some embodiments), the AP may not transmit to the wireless device.

FIG. 30 illustrates an uncertainty window, according to some embodiments. As shown, during the uncertainty window before or after an SP (e.g., for BLE communication, in the illustrated case, but this can apply to any type of SP), the AP may not transmit to the wireless device.

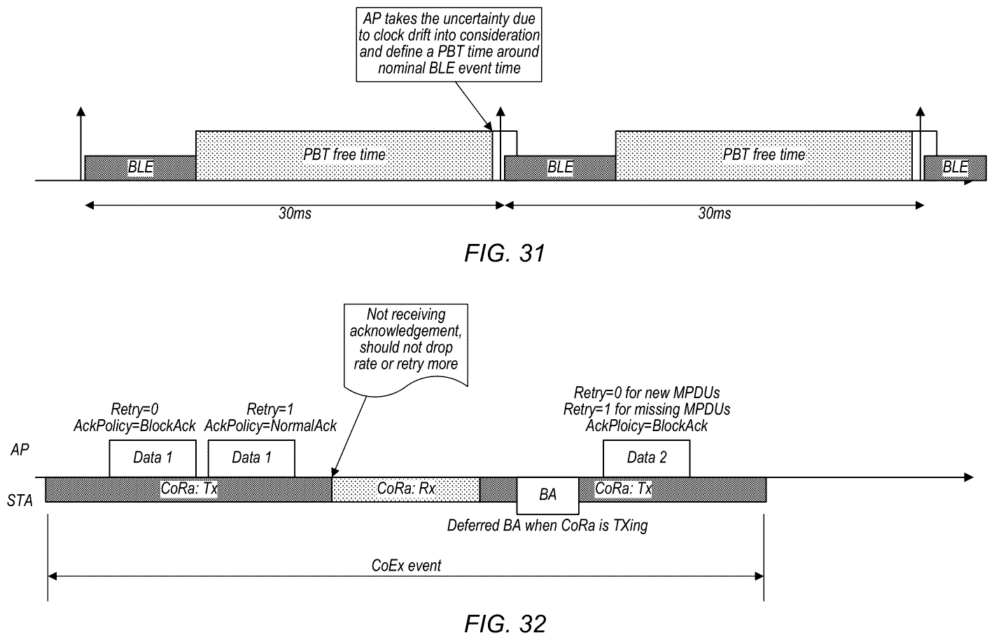

FIG. 31 illustrates an uncertainty window with PBT techniques, according to some embodiments. PBT free time can represent time between SPs and outside of uncertainty windows when the wireless device can be assumed to be fully available. During an uncertainty window (e.g., for BLE communication, in the illustrated case, but this can apply to any type of SP), the AP can perform PBT prior to transmitting to the wireless device. In other words, the AP can transmit a request to send (RTS) to the wireless device. If a clear to send (CTS) is received in response, the AP can transmit to the wireless device during the remainder of the uncertainty window (and into any following PBT free time). Otherwise, the AP may not transmit during the uncertainty window.

Note that FIGS. 30 and 31 illustrate uncertainty windows associated with the beginning of the SP. However, in various embodiments, uncertainty windows can be used at the end of the SP (e.g., corresponding to the beginning of the PBT free time) in addition to or instead of the beginning of the SP.

Thus, the communication 2814a can include timing updates from the wireless device to the AP and/or PBT by the AP (2818), according to some embodiments.

As another example, the communication 2814a can include transmission to/from the wireless device during one or more SP, e.g., within the limits of the co-located radio interference level. FIG. 32 illustrates techniques associated with communication between the wireless device and AP during a coexistence event related SP, according to some embodiments. For example, if the wireless device has indicated (e.g., in 2806) that limited communication can be possible during the SP(s), such limits can be applied and first communication can occur during the SP(s). For example, if the wireless device has indicated a sensitivity, the AP can apply proper rate adaptation accordingly. Additionally, the wireless device can provide short term information about sensitivity (e.g., an indication to assume de-sense [x] dB for the next [y] milliseconds, etc.) and the AP can use this information for rate adaptation. The AP can transmit to the wireless device using the adapted rate during the SP(s). Further, the limit the aggressiveness of link adaptation and/or limit the unsolicited retry of DL data during the SP.

Such transmission of DL data can be associated with a flexible approach to acknowledgement. For example, acknowledgement of DL data during an SP can be delayed. The delay can be until after the end of the SP or until the co-located radio is in a Tx mode. For example, it can be beneficial to avoid WiFi::CoRa==TX::RX, if CoRa is in-band. Thus, the wireless device can defer unsolicited acknowledgement. The wireless device can transmit the acknowledgement opportunistically when the collocated radio is transmitting (e.g., WiFi::CoRa==TX::TX).

### Additional Information and Examples

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In one set of embodiments, a method can comprise: establishing first wireless local area network (WLAN) communication with an access point (AP) and determining a channel usage preference for the WLAN communication based at least in part on second communication, wherein the second communication is not with the AP.

In some embodiments, the method can include: transmitting, to the AP, a channel usage request, the channel usage request indicating the channel usage preference.

In some embodiments, the method can include: receiving, from the AP, a channel usage response, the channel usage response indicating at least one target wake time (TWT) element.

In some embodiments, the method can include: determining, based on the at least one TWT element, a schedule for reduced availability for communication with the AP, the schedule for the reduced availability for communication with the AP comprising a plurality of service periods of reduced availability.

In some embodiments, the method can include: determining a modification to the schedule for the reduced availability for communication with the AP.

In some embodiments, the method can include: transmitting, to the AP, an indication of the modification of the schedule for the reduced availability for communication with the AP.

In some embodiments, the method can include: performing at least one of the first communication with the AP or the second communication according to the modification of the schedule for the reduced availability for communication with the AP.

In some embodiments, the modification to the schedule for the reduced availability for communication with the AP comprises starting a first service period of reduced availability late and reducing a duration of the first service period.

In some embodiments, the modification to the schedule for the reduced availability for communication with the AP comprises starting a first service period of reduced availability late and ending the first service period late.

In some embodiments, the indication of the modification of the schedule for the reduced availability for communication with the AP comprises a first quality of service (QOS) Null with power management (PM) set to 0 transmitted during a first service period of reduced availability.

In some embodiments, the indication of the modification of the schedule for the reduced availability for communication with the AP further comprises a second QoS Null with PM set to 1 transmitted after the first QoS Null.

In some embodiments, the method further includes: being available to communicate with the AP between the first QoS Null and the second QoS Null; and being available to perform the second communication between the second QoS Null and an end of the first service period.

In some embodiments, the indication of the modification of the schedule for the reduced availability for communication with the AP comprises a first quality of service (QOS) Null with End of Service Period (EOSP) set to a first value transmitted during a first service period of reduced availability.

In some embodiments, the indication of the modification of the schedule for the reduced availability for communication with the AP further comprises a second QoS Null with EOSP set to a second value transmitted after the first QoS Null.

In some embodiments, the method further includes: being available to communicate with the AP between the first QoS Null and the second QoS Null; and being available to perform the second communication between the second QoS Null and an end of the first service period.

In some embodiments, the indication of the modification of the schedule for the reduced availability for communication with the AP comprises: a first quality of service (QOS) Null with power management (PM) set to 0 transmitted during a first service period of reduced availability; and a second QoS Null transmitted after the first QoS Null, wherein the second QoS Null comprises an End of Service Period (EOSP) field set to one of a first value or a second value, wherein: the first value indicates reduced availability for communication with the AP during a remainder of the first service period according to a current end time; the second value indicates reduced availability for communication with the AP during a complete duration of the first service period beginning from a time of the second QoS Null.

In some embodiments, the modification to the schedule for the reduced availability for communication with the AP comprises starting a first service period of reduced availability early and increasing a duration of the first service period.

In some embodiments, the modification to the schedule for the reduced availability for communication with the AP comprises starting a first service period of reduced availability early and maintaining a duration of the first service period.

In some embodiments, the indication of the modification of the schedule for the reduced availability for communication with the AP comprises a quality of service (QOS) Null with power management (PM) set to 1 transmitted prior to a scheduled start of a first service period of reduced availability.

In some embodiments, the indication of the modification of the schedule for the reduced availability for communication with the AP comprises a quality of service (QOS) Null with End of Service Period (EOSP) set to a first value transmitted prior to a scheduled start of a first service period of reduced availability.

In some embodiments, the first value indicates reduced availability for communication with the AP until a current end time of the first service period.

In some embodiments, the first value indicates reduced availability for communication with the AP until a modified end time of the first service period based on a complete duration of the first service period beginning from a time of the indication.

In some embodiments, the modification to the schedule for the reduced availability for communication with the AP is based on a request for modification received from the AP.

In some embodiments, the method can include: transmitting a response to the request for modification, the response indicating the modification to the schedule for the reduced availability for communication with the AP.

In some embodiments, the method can include: receiving a second request for modification; and transmitting a second response to the second request for modification, the second response indicating denial of the second request for modification.

In some embodiments, the modification to the schedule for the reduced availability for communication with the AP comprises one of: skipping a first service period of reduced availability; starting the first service period early; or shortening the first service period.

In some embodiments, the request for modification is received using a secondary radio.

In some embodiments, the modification to the schedule for the reduced availability for communication with the AP comprises making a main radio available for communication with the AP prior to a previously scheduled end of a first service period of reduced availability.

In some embodiments, request for modification comprises and initial control frame.

In some embodiments, the method can include: transmitting an indication of capability to return the main radio during a first service period.

In some embodiments, the indication of capability comprises a per-link indication of capability to receive a request to return the main radio to a different link.

In some embodiments, the method can include: establishing a plurality of links with the AP, wherein the channel usage request indicates to which link or links of the plurality of links the channel usage preference applies.

In some embodiments, the method can include: performing the second communication during a first service period.

In one set of embodiments, a method can comprise: providing a basic service set (BSS); and transmitting a broadcast (BC) target-wake-time (TWT) parameter set for the BSS, wherein the BC TWT indicates an service period (SP) during which the BSS will be unavailable via at least one link.

In some embodiments, the BC TWT parameter set is transmitted in a channel usage request frame.

In some embodiments, the BC TWT parameter set is transmitted in a channel usage response frame.

In some embodiments, the BC TWT parameter set is transmitted in association with a first indication of one or more links which will be unavailable during the SP.

In some embodiments, the method can include: receiving, during the SP via a first link that is available during the SP, a request to make a second link available for at least a portion of the remainder of the SP, wherein the first indication indicates the second link as unavailable during the SP.

In some embodiments, the method can include: activating, in response to the request, the second link for the portion of the remainder of the SP.

In one set of embodiments, a method can comprise: establishing wireless local area network (WLAN) communication with an access point (AP); determining coexistence information related to the WLAN communication, the coexistence information comprising at least one of: information related to clock drift; information related to an interference level of a co-located radio; detailed timing information of one or more coexistence event; or channel mapping information.

In some embodiments, the method can include: transmitting, to the AP, an indication of the coexistence information.

In some embodiments, the method can include: communicating, with the AP, according to the coexistence information.

In some embodiments, the coexistence information comprises the information related to clock drift, wherein transmitting, to the AP, the indication of the coexistence information comprises transmitting periodic timing updates.

In some embodiments, the periodic timing updates are transmitted using one of the following: a target wake time (TWT) information frame; an action frame for clock synchronization; a frame with an A-Control field included in a media access control (MAC) header; or a block-acknowledgement frame.

In some embodiments, the method can include: receiving a request to send (RTS) message from the AP during an uncertainty window related to the clock drift.

In some embodiments, the method can include: in response to the RTS, transmitting, to the AP, a clear to send (CTS) message.

In some embodiments, the CTS message indicates an amount of time prior to a next service period of reduced availability for communication with the AP.

In some embodiments, the coexistence information comprises the information related to the interference level of the co-located radio, wherein transmitting, to the AP, the indication of the coexistence information comprises transmitting an indication of a sensitivity level of a WLAN radio during a first period of time that the co-located radio is active.

In some embodiments, the method can include: determining to defer transmission of a block acknowledgement to the AP at a first time when the co-located radio is not transmitting.

In some embodiments, the method can include: determining to transmit the block acknowledgement to the AP at a second time, after the first time, when the co-located radio is transmitting.

In some embodiments, the coexistence information comprises the detailed timing information of the one or more coexistence event.

In some embodiments, the method can include: the detailed timing information of the one or more coexistence event comprises: dividing a first service period of reduced availability for communication with the AP associated with the one or more coexistence event into a plurality of segments, wherein a first segment is for transmission and a second segment is for reception.

In some embodiments, the detailed timing information of the one or more coexistence event is based on a fixed traffic pattern and is applied to multiple service periods of reduced availability for communication with the AP.

In some embodiments, the coexistence information comprises the channel mapping information, wherein the channel mapping information comprises an indication of a recommended channel puncture associated with a coexistence event.

In some embodiments, the coexistence information comprises the channel mapping information, wherein the channel mapping information comprises an indication of a recommended secondary channel associated with a coexistence event.

In some embodiments, the coexistence information comprises the channel mapping information, wherein the channel mapping information comprises an indication of one of more frequencies of a coexistence event.

In some embodiments, the coexistence information comprises the channel mapping information, wherein the channel mapping information comprises an indication of a recommended channel selection associated with a coexistence event.

Any of the methods described herein (including in the following claims) for operating a wireless device (e.g., client) can be the basis of a corresponding method for operating an AP and vice versa, e.g., by interpreting each message/signal X received by the wireless device in the downlink as message/signal X transmitted by the AP, and each message/signal Y transmitted in the uplink by the wireless device as a message/signal Y received by the AP. Moreover, a method described with respect to an AP can be interpreted as a method for a wireless device in a similar manner. Similarly, any of the methods described above can be interpreted as a method for a controller.

Embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a wireless device can be configured to include a processor (and/or a set of processors) and a memory medium, where the memory medium stores program instructions, where the processor is configured to read and execute the program instructions from the memory medium, where the program instructions are executable to cause the wireless device to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A processor comprising memory configured to cause the processor to perform operations comprising:
establishing a first wireless local area network (WLAN) connection with an access point (AP);
determining a channel usage preference for the WLAN connection based at least in part on a second connection, wherein the second connection is with a second device other than the AP;
encoding, for transmission to the AP, a channel usage request, the channel usage request indicating the channel usage preference;
decoding, from the AP, a channel usage response, the channel usage response indicating at least one target wake time (TWT) element;
determining, based on the at least one TWT element, a schedule for reduced availability for communication with the AP, the schedule for the reduced availability for communication with the AP comprising a plurality of service periods of reduced availability;
determining a modification to the schedule for the reduced availability for communication with the AP;
encoding, for transmission to the AP, an indication of the modification of the schedule for the reduced availability for communication with the AP; and
performing at least one of a first communication with the AP or a second communication with the second device according to the modification of the schedule for the reduced availability for communication with the AP.

2. The processor of claim 1, wherein the modification to the schedule for the reduced availability for communication with the AP comprises at least one of:
starting a first service period of reduced availability late and reducing a duration of the first service period; or
skipping the first service period.

3. The processor of claim 1, wherein the modification to the schedule for the reduced availability for communication with the AP comprises at least one of:
starting a first service period of reduced availability late; or
ending the first service period late.

4. The processor of claim 1, wherein the indication of the modification of the schedule for the reduced availability for communication with the AP comprises a first quality of service (Qos) Null with power management (PM) set to 0 transmitted during a first service period of reduced availability.

5. The processor of claim 4, wherein the indication of the modification of the schedule for the reduced availability for communication with the AP further comprises a second QoS Null with PM set to 1 transmitted after the first QoS Null, wherein the operations further include:
being available to communicate with the AP between the first QoS Null and the second QoS Null; and
being available to perform the second communication between the second QoS Null and an end of the first service period.

6. The processor of claim 1, wherein the indication of the modification of the schedule for the reduced availability for communication with the AP comprises a first quality of service (QOS) Null with End of Service Period (EOSP) set to a first value transmitted during a first service period of reduced availability.

7. The processor of claim 1, wherein the indication of the modification of the schedule for the reduced availability for communication with the AP comprises:
a first quality of service (QOS) Null with power management (PM) set to 0 transmitted during a first service period of reduced availability; and
a second QoS Null transmitted after the first QoS Null, wherein the second QoS Null comprises an End of Service Period (EOSP) field set to one of a first value or a second value, wherein:
the first value indicates reduced availability for communication with the AP during a remainder of the first service period according to a current end time; and
the second value indicates reduced availability for communication with the AP during a complete duration of the first service period beginning from a time of the second QoS Null.

8. A method, comprising:
providing, a basic service set (BSS); and
transmitting a broadcast (BC) target-wake-time (TWT) parameter set for the BSS, wherein the BC TWT indicates a service period (SP) during which the BSS will be unavailable via at least one link.

9. The method of claim 8, wherein the BC TWT parameter set is transmitted in a channel usage request frame.

10. The method of claim 8, wherein the BC TWT parameter set is transmitted in a channel usage response frame.

11. The method of claim 8, wherein the BC TWT parameter set is transmitted in association with a first indication of one or more links which will be unavailable during the SP.

12. The method of claim 11, further comprising:
receiving, during the SP via a first link that is available during the SP, a request to make a second link available for at least a portion of the remainder of the SP, wherein the first indication indicates the second link as unavailable during the SP; and
activating, in response to the request, the second link for the portion of the remainder of the SP.

13. A processor comprising memory configured to cause the processor to perform operations comprising:
generating a wireless local area network (WLAN) communication with an access point (AP);
determining coexistence information related to the WLAN communication, the coexistence information comprising at least one of:
information related to a clock drift;
information related to an interference level of a co-located radio;
detailed timing information associated with one or more coexistence events; or
channel mapping information;
encoding, for transmission to the AP, an indication of the coexistence information; and
generating a communication, intended for the AP, according to the coexistence information.

14. The processor of claim 13, wherein the coexistence information comprises the information related to the clock drift, wherein the indication of the coexistence information comprises one or more periodic timing updates.

15. The processor of claim 14, wherein the one or more periodic timing updates are encoded using one of the following:
a target wake time (TWT) information frame;
an action frame for clock synchronization;
a frame with an A-Control field included in a media access control (MAC) header; or
a block-acknowledgement frame.

16. The processor of claim 14, the operations further comprising:
receiving a request to send (RTS) message from the AP during an uncertainty window related to the clock drift; and
in response to the RTS, generating a clear to send (CTS) message, addressed to the AP.

17. The processor of claim 16, wherein the CTS message indicates an amount of time prior to a next service period of reduced availability for communication with the AP.

18. The processor of claim 13, wherein the coexistence information comprises the detailed timing information of the one or more coexistence event, wherein the detailed timing information of the one or more coexistence events comprises:
dividing a first service period of reduced availability for communication with the AP associated with the one or more coexistence events into a plurality of segments, wherein a first segment is for transmission and a second segment is for reception.

19. The processor of claim 13, wherein the coexistence information comprises the channel mapping information, wherein the channel mapping information comprises an indication of a recommended channel puncture associated with a coexistence event.

20. The processor of claim 13, wherein the coexistence information comprises the channel mapping information, wherein the channel mapping information comprises an indication of a recommended secondary channel associated with a coexistence event.
